(19) United States
(12) Patent Application Publication
(10) Pub. No.: US 2026/0278153 A1
(43) Pub. Date: Sep. 17, 2026

(54) DIGITAL PROFILE MONITORING PLATFORM AND METHOD

(71) Applicant: State Farm Mutual Automobile Insurance Company, Bloomington, IL (US)

(72) Inventors: Phillip M. Wilkowski, Gilbert, AZ (US); Alexander Cardona, Gilbert, AZ (US); Laura A. Uphoff, Gilbert, AZ (US); Daniel Wilson, Phoenix, AZ (US)

(21) Appl. No.: 19/540,062

(22) Filed: Feb. 13, 2026

Related U.S. Application Data
(60) Provisional application No. 63/772,116, filed on Mar. 14, 2025.

(51) Int. Cl. G06F 21/62; G06F 3/0482

(52) U.S. Cl. CPC G06F 21/6245; G06F 3/0482

(57) ABSTRACT

A computer system for detecting and monitoring a digital profile of a user within a computer network environment is provided. The computer system is programmed to: (1) receive user data from a user device, (2) execute a machine learning model to identify a digital profile of the user from the received user data including extracting digital profile data from the user data, (3) detect, using the machine learning model and the identified digital profile of the user, an instance of the digital profile data stored within the computer network environment, (4) cause an alert to be displayed on the user device advising the user of the detected instance of the digital profile data, (5) receive user input from the user device, and/or (6) determine at least one monitoring operation for monitoring the detected instance of the digital profile data based upon the received user input.

### CROSS-REFERENCE TO RELATED APPLICATIONS

This application claims priority to U.S. Provisional Patent Application No. 63/772,116, filed Mar. 14, 2025, entitled “DIGITAL PROFILE MONITORING PLATFORM AND METHOD,” the entire content and disclosure of which is hereby incorporated herein by reference in its entirety.

### FIELD OF DISCLOSURE

The present disclosure generally relates to a digital profile monitoring platform for monitoring personal data stored within a computer environment, and, more particularly, to a centralized digital profile monitoring platform and computer-implemented methods for identifying, generating, and managing digital personal user data, and generating a centralized dashboard application for seamless access and use that allows the user to control the online exposure of their personal data.

### BACKGROUND

As digital profiles proliferate across various computer platforms and devices, managing and monitoring these profiles have become increasingly complex. Users may often engage with multiple online platforms, each requiring distinct sets of personal information, privacy settings, and preferences. This fragmentation may result in users manually tracking, updating, and securing their digital profiles, which may lead to significant inefficiencies and potential oversights. For example, a user may create an account on a social media platform, update their profile on a professional networking site, and manage subscription preferences on a third platform, each operating in isolation. This disjointed approach may make it difficult to maintain a consistent and secure online presence.

Conventional digital profile management techniques typically rely on manual effort, lack automated tools for identifying and managing profiles across platforms, and/or fail to leverage advanced technologies like machine learning and artificial intelligence (AI) tools for profile detection and monitoring. These and other limitations may result in a fragmented user experience, increased vulnerability to data breaches, and/or missed opportunities to enhance privacy and efficiency. Moreover, conventional methods fail to adequately address the integration of unstructured data, fail to provide real-time monitoring, and/or lack user-friendly interfaces for centralized control. These inefficiencies may include additional drawbacks, such as ineffective data correlation, difficulty in identifying incomplete or missing profile attributes, and limited scalability in managing multiple profiles. Conventional techniques may include additional inefficiencies, encumbrances, ineffectiveness, and/or other drawbacks as well.

### BRIEF SUMMARY

The present embodiments may relate to, inter alia, computer systems and computer-based methods for automatic digital profile detection, management, and monitoring. In one exemplary embodiment, the digital profile system employs a machine learning model and/or AI tools trained to analyze user data from one or more user devices in order to identify digital profiles of one or more users. These profiles may include usernames, links, metadata, or other identifying elements derived from user interactions, such as emails, social media activity, or other unstructured data. Once identified, the digital profile system processes these profiles to generate monitoring plans, which may include actions such as updating privacy settings, removing data, and/or encrypting sensitive information.

The digital profile system integrates monitoring plans and data into a centralized dashboard application accessible across multiple user devices. This dashboard provides real-time updates and enables users to view, confirm, and/or manage monitoring operations of the generated monitoring plan. In some embodiments, the digital profile system may generate recommendations for actions, such as removing unauthorized instances of user data or suggesting privacy updates, based upon detected profile attributes or user-defined rules. The system may also identify associated accounts or related profiles, and initiate corresponding monitoring operations, such as issuing notifications or performing batch monitoring operations.

The embodiments described herein leverage advanced data analysis to enhance digital profile management and ensure accurate monitoring operations. For instance, the digital profile system may identify pre-existing profiles or incomplete data, and take corrective actions to refine the monitoring plan. Machine learning and/or AI models may be trained on historical profile data to improve detection accuracy and recommendations. These models may further be configured to extrapolate incomplete data, search relevant sources, and/or automatically supplement detected profiles with missing information. By combining automated searches, data enrichment, and centralized monitoring, the system provides an intelligent and adaptive solution for managing digital profiles effectively.

The digital profile monitoring system may include a digital profile server or computing device that may be communicatively coupled to a database or other memory, wherein the digital profile server stores the detected digital profiles in a common format. The digital profile system may be further configured to translate disparate data having different formats into a common format for easy storage, retrieval, and/or management of that data.

In one aspect, a computer system for detecting and monitoring a digital profile of a user within a computer network environment may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, machine learning models, ChatGPT or ChatGPT-based bots, generative AI-based bots, and/or other electronic or electrical components, which may be in wired or wireless communication with one another. For example, in one instance, the computer system may include at least one processor and/or associated transceiver in communication with (i) at least one memory device, (ii) a user device associated with a user, and (iii) at least one computer network environment. The at least one processor may be programmed to: (1) receive user data from the user device of one or more user computer devices, (2) execute a machine learning model to identify a digital profile of the user from the received user data including extracting digital profile data from the received user data, (3) detect, using the machine learning model and the identified digital profile of the user, an instance of the digital profile data stored within the computer network environment, (4) cause an alert to be displayed on (and/or audibly presented via) the user device advising the user of the detected digital profile data, (5) receive user input from the user device in response to the alert; and/or (6) determine at least one monitoring operation for monitoring the detected instance of the digital profile data based upon the received user input. The computer system may have additional, less, or alternate functionality, including that discussed elsewhere herein.

In another aspect, a computer-implemented method for detecting and monitoring a digital profile of a user within a computer network environment may be provided. The computer-implemented method may be implemented using a computing system having one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, machine learning models, ChatGPT or ChatGPT-based bots, generative AI-based bots, and/or other electronic or electrical components, which may be in wired or wireless communication with one another and function as input and/or output devices. For example, in one instance, the computer-implemented method may be implemented by a computer system including at least one processor and/or associated transceiver in communication with (i) at least one memory device, (ii) a user device associated with a user, and (iii) at least one computer network environment. The computer-implemented method may be implemented using the one or more local or remote processors and/or transceivers. The method may include: (1) receiving the user data from a user device of the one or more user computer devices, (2) executing a machine learning model to identify a digital profile of the user from the received user data including extracting digital profile data from the received user data, (3) detecting, using the machine learning model and the identified digital profile of the user, an instance of the digital profile data stored within the computer network environment, (4) causing an alert to be displayed on (and/or audibly presented or generated via) the user device advising the user of the detected digital profile data, (5) receiving user input from the user device in response to the alert; and/or (6) determining at least one monitoring operation for monitoring the detected instance of the digital profile data based upon the received user input. The method may include additional, less, or alternate actions, including those discussed elsewhere herein.

In yet another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device. The computer-executable instructions may direct or cause the at least one processor and/or associated transceiver to: (1) receive user data from a user device of one or more user computer devices, (2) execute a machine learning model to identify a digital profile of the user from the received user data including extracting digital profile data from the received user data, (3) detect, using the machine learning model and the identified digital profile of the user, an instance of the digital profile data stored within a computer network environment, (4) cause an alert to be displayed on (and/or audibly presented via) the user device advising the user of the detected digital profile data, (5) receive user input from the user device in response to the alert; and/or (6) determine at least one monitoring operation for monitoring the detected instance of the digital profile data based upon the received user input. The computer-readable media may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the computer systems and computer-based methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a digital profile monitoring computing system according to an exemplary embodiment of the present disclosure.

FIG. 2 illustrates a schematic diagram of an exemplary digital profile monitoring server in communication with at least one user device according to an exemplary embodiment of the present disclosure as shown in FIG. 1.

FIG. 3 illustrates a simplified block diagram of an exemplary digital profile monitoring computer system as shown in FIGS. 1 and 2 according to an exemplary embodiment of the present disclosure.

FIG. 4 illustrates an exemplary configuration of a user computer system as shown in FIGS. 1 and 2 according to an exemplary embodiment of the present disclosure.

FIG. 5 illustrates an exemplary configuration of a user computer device shown in FIG. 4 according to an exemplary embodiment of the present disclosure.

FIG. 6 illustrates an exemplary configuration of a server computer device as shown in FIGS. 1 and 2 according to an exemplary embodiment of the present disclosure.

FIG. 7 is a flow chart of an exemplary computer-implemented process implemented by a digital profile monitoring system as shown in FIGS. 1 and 2 in accordance with the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

As described herein, the present embodiments may relate to, inter alia, computer systems and computer-based methods for monitoring digital profiles identified from user data that are stored within or processed by external platforms and/or computer network environments. In some cases, these digital profiles include personal data that the user may or may not want exposed to others within the computer network environments. In one exemplary embodiment, the digital profile monitoring or management system and computer-implemented method may use a machine learning or AI model to analyze user data from one or more user devices to generate a digital profile of the user that then gets used to further detect and modify instances of the digital profile stored within a computer network environment. A digital profile may include an online presence, identity data, personal data, and/or entity data that is associated with a particular user. Digital profile data may include information such as usernames, account details, personal attributes, references to social media profiles, and/or other identifying characteristics available on the internet. The digital profile data may include personally identifiable (PII) data and/or personal health related data that the user may not want exposed to others within the computer network environment.

As described further herein, the digital profile may be detected within a computer environment based upon the user data received from the user, which may be sourced from one or more user devices, applications, web platforms, and other user data sources. The digital profile monitoring system may execute the machine learning model based upon the user data to detect an instance of the digital profile within a computer environment. When an instance of digital profile is detected, the digital profile monitoring system may generate a monitoring plan for each instance of the digital profile.

The monitoring plan may facilitate monitoring operations for the digital user data associated with the digital profile, such as restricting access, removing the instance, or modifying the visibility of the digital user data. For example, the digital profile monitoring system may receive a name and date of birth associated with the user. The system may execute a machine learning or AI model to detect an instance of digital user data based upon the provided user data to determine a monitoring operation and generate the monitoring plan. Further, the digital profile monitoring system may provide the generated monitoring plan into a centralized dashboard application. The dashboard may provide real-time updates associated with the monitoring operations of the generated monitoring plan, allowing users to view and manage the monitoring plan. The dashboard application may be viewable by the user through a website or may be viewable on a user device via a computer application (e.g., an app) executing on the user device after being downloaded from a server.

In one exemplary embodiment, the disclosed process may be performed by the profile monitoring computer system. The digital profile monitoring system may include a web server associated with a service provider that manages and presents profile monitoring options to the user. In some embodiments, the web server may execute the machine learning and/or AI models for identifying the digital profiles existing within the computer environments and generating a plan to address each instance of the digital profiles to ensure that the user is able to protect or prevent exposure of such data.

The system may be configured to generate and train the machine learning models using historical user data to improve digital profile detection and monitoring. For example, when the system receives user data that includes insufficient data to initially detect an instance of the digital user data, the machine learning model may be trained on historical user data to supplement the initial user data (using a predictive output from the model based on past trends and data pattern recognition) so as to be able to detect the digital profile. The machine learning model may be configured to extrapolate the received user data to identify additional user data based upon the machine learning model. In this way, the system ensures that each instance of the digital user data is detected. The machine learning model may also be trained to conduct automated searches including where to search (e.g., URLs or other locations accessible by computing devices) for instances of the digital profile data.

The profile monitoring system may process a variety of user data that may be used to detect the digital profile within the computer network environments. Given the nature of digital data, both the incoming user data and the detected instances of the digital profile may be highly unstructured. For example, the digital profile data detected by the system may include text-based posts, images, screen captures, and other multimedia elements. Further, the user data received by the system to facilitate detection of the instance of the digital profile may also include various forms of data. The unstructured data, both among the user data and the digital profile data, is processed by the system using machine learning models and advanced data analysis techniques to accurately detect, extract, and interpret digital profile indicators from the user data. Applying the machine learning models to the user data improves the detectability of an instance of the digital user profile and improves the accuracy of the representation of the user’s online presence.

In some embodiments, the digital profile monitoring system may receive user data from multiple sources, including but not limited to emails, text messages, social media platforms, government database, medical database, financial database, insurance database, screen data, and other application interactions where user data may be collected and/or stored. Further, the profile monitoring system may receive the user data from a plurality of devices associated with the user. For example, the system may receive user data including a social media mention from a first device, and a forum post from another computing device. The user data may be analyzed by the profile monitoring system to determine hints or cues that enable the detection of an instance of a particular digital profile stored within a computer network environment (e.g., on the internet or other network).

In various embodiments, multiple profile references and attributes of the user data may define the type of digital profile. For example, the system may determine if the digital profile corresponds to a social media account, personal information, financial information, insurance information, and/or health information. Managing the plurality of instances of the digital profile data and grouping them by common attributes ensures the system can track and manage the entirety of the user’s digital profile.

Further, the digital profile monitoring system may be programmed to execute the machine learning model to analyze the received user data and extract profile indicators such as usernames, links, or personal identifiers. The machine learning model may perform keyword searches, pattern recognition, and computer vision techniques, allowing it to identify instances of a digital profile when the initial user data is incomplete or scattered. Once the profile type is determined, the system can combine monitoring operations across each of the instances of the digital profile to generate the monitoring plan. Grouping the detected instances of the digital profile data enables consistent profile monitoring by adjusting privacy settings, issuing data removal commands, or encrypting sensitive information across each instance of the detected digital profile.

In the example embodiment, the digital profile monitoring system may receive user data from one or more user devices. The detection server may incorporate data analysis modules configured to identify potential profile indicators from the received user data. Static data elements, such as familiar platform-specific terms or standardized profile labels, may be used to structure the recognition process. Dynamic data elements, including usernames, timestamps, social media handles, or contextual metadata, across the plurality of instances.

Identifying static and dynamic elements and understanding their contextual relationships may enable the system to accurately form a structured representation of the detected digital profiles associated with the user data. For example, the received user data used to locate the digital profiles may include a social media handle and a post including digital profile information. The system may be configured to identify the social media platform associated with the handle as a static data element and the social media handle as the dynamic data element. Analyzing both the static data elements and the dynamic data elements enables the digital profile monitoring system to improve groupings of the instances of the digital profile data to generate the monitoring plan.

In various embodiments, the profile monitoring system may be deployed on a user device. For example, the monitoring system may be deployed on a user device through a computer app that is stored and executed on the user device. The system, via the computer app or other means, may leverage computer vision methods to interpret screen data, such as screenshots of a user’s online account settings, profile pages, or online transactions, to detect the underlying digital profile while the user interacts with the user device. This approach helps compensate for inconsistent data structures, incomplete references, or user data that lacks standardized formatting. Executing the machine learning models and performing the pattern recognition improves accuracy and consistency of digital profile detection, ensuring that the identified digital profile aligns with the user’s actual online presence.

In the example embodiment, the system may further include an analysis module to group similar digital profile instances together. By evaluating common attributes, the analysis module may determine that multiple instances correspond to the same digital profile source. For example, the static data elements may correspond to a social media platform to group the instances of the digital profile together. Further, the dynamic data elements may be grouped to determine the scope of the digital profile associated with the social media platform. The references can be combined and stored as one or more records in a database, representing a unified view of the user’s digital profile. In some embodiments, the system may be configured to store the grouped instances of the digital profile user data based upon the original source of the detected instance.

In various embodiments, each data entry of an instance may include user identifiers, contextual information, and the identified digital user data. In some embodiments, the system may process the plurality of instances using thresholds or criteria to define how multiple instances correspond. For example, the system may calculate a similarity score based the digital profile data of the instance of the digital profile.

When multiple instances meet or exceed a predefined similarity threshold, they are grouped as corresponding to the digital profile. For example, a high similarity score may indicate that the instances result from the same or similar digital profile. Alternatively, a low similarity score may indicate that each instance of the digital profile corresponds to different digital user profiles.

The profile monitoring system may include a machine learning model within the analysis module to improve digital profile detection. For example, the system may detect a digital profile reference without security preferences and may determine suitable monitoring operations.

The monitoring operations may include modifying and/or removing the detected instance of the digital profile. For example, the monitoring operation may include masking personal data or restricting accessibility for the detected instance.

Further, the machine learning model may be configured to detect the presence of the digital user profile on additional unrelated accounts. For example, the machine learning program may be configured to determine where the digital user data has been posted beyond the profiles of the user (e.g., posted by another user, copied to an unauthorized profile, or other misuse of the digital profile data). The machine learning model may train on historical profile data to better recognize correlations and identify additional instances of the user data from incomplete data. Further, the machine learning model can further improve detection of the digital profile based upon continuous refinement through user feedback.

In some embodiments, the machine learning model may interact with an external source to gather additional details about the digital profile of the user. For example, the system may access remote servers to request updates, removal of certain data, receive additional user data, and/or to implement stricter privacy measures. In some embodiments, the system may prompt the user for input, offering them icons or controls that represent specific monitoring operations based upon the generated monitoring plan.

In the example embodiment, the digital profile monitoring system may analyze each instance of the digital profile data to determine what monitoring operations to present or execute for the generated monitoring plan. The system may process each of the instances to confirm that multiple instances correspond to the digital profile. Validating the digital profile ensures the generated monitoring plan includes requested monitoring operations (e.g., removal, encryption, or access limitation) are accurately applied to the correct profile. When updates to the user data or the digital profile data are detected, the system may modify the monitoring plan and incorporate the additional data.

In the example embodiment, the detection of an instance of the digital profile may result in the generation of a monitoring plan. The monitoring plan may include monitoring operations associated with each instance of the detected digital user profile. For example, if several user-selected profile icons indicate a desire for strict privacy, the system may enforce encryption, send data removal requests, and update platform settings accordingly.

The profile monitoring system described herein may include a monitoring plan generation module (or a monitoring plan module) capable of communicating with user devices and external platforms. The monitoring plan generation module may store instances of the detected digital profile and apply corresponding monitoring operations. As the system process the user data, the generated monitoring plan modifies the monitoring operations (e.g., privacy parameters or access restrictions) that are common across each of the identified instances. Centralizing the monitoring plan enables the system to retrieve, update, and execute the monitoring operations based upon the user’s selection.

As the system receives additional user data from the user or user devices, the profile monitoring system may identify additional instances of the digital profiles stored within the computer environment and refine the monitoring plan. The profile monitoring system may determine whether the additional user data matches any existing instances and, if not, determines whether a new monitoring plan should be generated. The monitoring plan may span multiple platforms and use cases, resulting in integrated profile management which is a substantial improvement over conventional, disorganized approaches. In contrast, certain known systems rely on manual input or isolated detection, and do not utilize machine learning or automated pattern recognition.

The systems and methods described herein provide a framework for monitoring and managing a user's digital profile stored within a computer network environment. The digital profile monitoring system includes at least one memory device configured to store data and instructions, and at least one processor operatively coupled to the memory device. The processor is further configured to communicate with one or more user computer devices, such as smartphones, tablets, or personal computers, over a network. The system receives initial user data from a user computer device, wherein the user data comprises information indicative of the user's online identity, including but not limited to, usernames, account credentials, personal attributes, and/or associated digital content.

When the system receives the user data, the system employs a machine learning or AI model executed by the processor to process and analyze the user data. This model may be trained to identify the user’s digital profile by extracting relevant data elements, such as text-based identifiers and/or multimedia content, that collectively represent the user's online presence across various platforms. The identified digital profile serves as the basis for subsequent operations performed by the system.

The system further utilizes the machine learning model to detect instances of the digital profile data stored within the computer network environment(s). The computer network environment encompasses a range of platforms, including but not limited to websites, social media networks, and third-party databases, where the user’s digital profile data may be stored or referenced. The detection process includes scanning the platforms on the computer network environment platforms to locate matches or occurrences of the digital profile data to map the extent of the user's online presence.

In the example embodiment, the profile monitoring system is configured to transmit a notification to the user computer device when an instance of the digital profile data is detected within the computer environment. The notification, displayed as an alert on the user interface of the device, informs the user of the detected instance and its location within the network environment. The alert provides the user with visibility into their digital profile’s distribution and prompts further interaction with the system.

In response to the notification, the system receives user input from the user computer device, specifying the user’s preferences for managing the detected instance. Based upon this input, the processor determines at least one monitoring operation to be executed with respect to the digital profile data. The monitoring operation includes at least one of, for example, the removal of the data from a platform, the restriction of access to the data, or the application of security measures such as encryption.

The system transmits executable instructions to the user computer device, causing the display of a plurality of icons on the device's user interface to enable user selection of monitoring operations. Each icon corresponds to a distinct monitoring operation applicable to the detected instance of the digital profile data. For example, one icon (when selected) may initiate data deletion, another when selected may restrict visibility to authorized parties, and a third icon when selected may apply encryption protocols. The user selects one or more icons, and the system receives this selection as user input, subsequently executing the associated monitoring operation(s) across the relevant platforms or repositories.

In certain embodiments, the system may be configured to generate a monitoring plan tailored to the user's digital profile. The monitoring plan may consolidate the user-selected monitoring operations into a structured approach for managing multiple instances of the digital profile data across the network environment. The system may execute the monitoring plan via the machine learning model, coordinating actions such as data removal or modification, and generates a report summarizing the outcomes, which is transmitted to the user computer device for display.

Additionally, the system may incorporate a natural language processing model to enhance the management of sensitive information within the digital profile data. Upon detecting an instance, the system may analyze the content to identify sensitive elements, such as personal identification numbers or financial details or health related details. The processor may then apply protective measures, such as encryption or selective removal, updating the instance accordingly to safeguard the user’s privacy.

The digital profile monitoring system further supports adjustments to privacy settings through the user interface. In the example embodiment, each displayed icon may be associated with a predefined privacy configuration, enabling the user to modify access levels or enhance data security with a single selection. For example, an icon selection by the user may cause to limit the visibility of the digital profile data or strengthen encryption parameters, as dictated by the user’s preferences.

In instances where the user opts for removal of the digital profile data, the digital profile monitoring system may transmit a data removal command to the hosting platform or repository. The data removal command includes instructions executable by the platform or repository to delete, mask, or otherwise eliminate the specified data from the platform or repository. The command may also include a directive to confirm permanent removal with the platform's administrator.

The digital profile monitoring system may be designed for continuous operation, periodically analyzing external data sources to acquire additional user data. The additional data may update the digital profile stored, enabling the detection of new instances of the digital profile data within the network environment. The processor may adapt the monitoring operations to address these new instances, ensuring ongoing management of the user's online presence. The system may generate parameters within the monitoring plan, including time intervals for recurring scans, data retention policies, and instance-based triggers for initiating expanded searches. These parameters may be customizable based upon user input, allowing the user to define privacy thresholds or prioritize specific instances of digital profile data for monitoring.

When the digital profile monitoring system detects security risks, such as the detection of a compromised password within the digital profile data, the system executes corrective actions, such as securing associated accounts. Similarly, if an email address is identified as subscribed to unwanted services, the system facilitates its unsubscription, enhancing the user's control over their digital footprint. The user data may also include biometric or facial recognition data into the digital profile. The machine learning model of the system then provides the user with options to retain or remove such instances of profile data from the network environment, executing the selected action accordingly.

The digital profile monitoring system may include at least one non-transitory computer-readable medium storing computer-executable instructions. When executed by a system comprising at least one memory device and at least one processor in communication with a user computer device, these instructions cause the processor to perform the operations described herein, including receiving user data, identifying the digital profile from the user data and monitoring the digital profile, detecting and managing instances of digital profile data stored with a computer environment, and executing user-directed monitoring plans.

These methods and systems may be implemented using a suitable combination of computer software, firmware, or hardware. The technical effect includes enhanced speed and accuracy in monitoring online profiles, leveraging machine learning to identify digital profile instances, and executing user-defined operations to better control personal digital profile data of a user that may be stored within a computer environment. This may include filtering through a wide array of unstructured data sources (e.g. emails, texts, social media mentions, screen captures, audio, video) to pinpoint, secure, or remove sensitive digital footprint elements and store or manage the resulting data in a centralized database.

Additionally, the profile monitoring system may employ machine learning models to detect missing or sensitive data and conduct automated searches to supplement user data with relevant details or remove undesired information. Once digital profiles are confirmed enriched, the system may create, modify, and save a monitoring plan aligned with the user’s preferences and chosen privacy settings. By implementing these features through sophisticated computing resources, the system reduces manual input and complexity, improves reliability, and enhances overall user control over their digital presence.

The computer-implemented methods and computer systems described herein may be implemented using computer programming or engineering techniques including computer software, firmware, hardware or any combination or subset thereof, wherein the technical effect may be achieved by performing at least one of the following actions or operations: (1) receiving user data from a user device of the one or more user computer devices, (2) executing a machine learning model to identify a digital profile of the user from the user data including extracting digital profile data from the user data, (3) detecting, using the machine learning model, an instance of the digital profile data stored within the computer network environment, (4) causing an alert to be displayed on the user device advising the user of the detected digital profile data, (5) receiving user input from the user device in response to the alert; and/or (6) determining at least one monitoring operation for monitoring the detected digital profile data based upon the received user input.

More generally, a technical effect of the systems and methods described herein may include improvements in leveraging technology such as machine learning tools and/or other artificial intelligence-based tools to improve the digital profile detection, monitoring, and user data protection. The system may translate various instances of the digital profile data derived from user data including emails, messages, postings, images, audio, video and/or unstructured data received from a user. The system may process the user data to generate a monitoring plan and execute at least one monitoring operation associated with the monitoring plan.

The digital profile monitoring system and computer-based method may also include identifying missing data associated with the digital profile from the received user data and may then utilize the machine learning models to cause an automated search to be conducted for additional data to supplement the user data in order to build a more complete user digital profile. The digital profile monitoring system may then generate a digital profile monitoring plan that includes the user data and the supplement data that may then be saved in a centralized location with the data stored in a common format. The methods and systems described herein may be implemented using computer programming or engineering techniques including computer software, firmware, hardware, or any combination or subset thereof.

The disclosed systems and methods for digital profile monitoring may also identify missing profile attributes associated with the digital user profile data obtained from the user. The system may execute the machine learning models to conduct automated searches to identify additional user data. Once the additional user data is processed by the profile monitoring system, the system may generate a monitoring plan incorporating instances of the digital profile associated with the user data and the additional user data. The digital profile monitoring system may be stored in a centralized database, allowing the digital profile information and monitoring plan to be maintained in a consistent, accessible format. These processes may be implemented using computer programming or engineering approaches, including computer software, firmware, hardware, or any combination thereof.

The present embodiments may relate to, inter alia, systems and methods for monitoring digital profiles. In one exemplary embodiment, the digital profile monitoring systems and methods may use a machine learning model to analyze user data from one or more user devices to detect and modify instances of a digital profile. A digital profile may include an online presence, identity, or entity associated with a particular user. Digital profile data may include information such as usernames, account details, personal attributes, references to social media profiles, and other identifying characteristics available on the internet.

As described further herein, the digital profile may be detected from the user data received from the user, which may be sourced from one or more user devices, applications, web platforms, and other user data sources. The digital profile monitoring system executes the machine learning model based upon the user data to detect an instance of the digital profile. When an instance of digital profile is detected, the system may generate a monitoring plan for each instance of the digital profile.

The monitoring plan may generate and execute monitoring operations for the digital user data associated with the digital profile, such as restricting access, removing the instance, or modifying the visibility of the digital user data. For example, the digital profile monitoring system may receive a name and date of birth associated with the user from the user device. The digital profile monitoring system may execute a machine learning model to detect an instance of digital user data based upon the provided user data to determine a monitoring operation and generate the monitoring plan. Further, the digital profile monitoring system may provide the generated monitoring plan into a centralized dashboard application. The dashboard may provide real-time updates associated with the monitoring operations of the generated monitoring plan, allowing users to view and manage the monitoring plan.

In some embodiments, the profile monitoring system may transmit executable instructions to a user computing device to display a plurality of profile icons on the device. Each profile icon may represent a specific monitoring operation associated with one or more instances of a detected digital profile. For example, the profile icons may correspond to operations such as removing digital user data, restricting access, updating privacy settings, encrypting sensitive information, or issuing data removal requests. The digital profile monitoring system processes the user input to determine the monitoring operation associated with the selected profile icon.

The determination process may include analyzing the selected input to map the user’s choice to a predefined monitoring operation stored within the system. For example, each profile icon may be associated with a privacy level of the user digital profile data. In some embodiments, the users may modify each privacy level.

The profile monitoring system may receive user input from the user computing device, where the input includes a selection of at least one profile icon associated with a desired monitoring operation. For instance, the user may select a “Remove” icon to initiate data removal or a “Restrict Access” icon to adjust privacy settings. The digital profile monitoring system processes the user selection to generate the profile monitoring operations to generate the digital profile monitoring plan.

In one exemplary embodiment, the disclosed process may be performed by the profile monitoring system. The profile monitoring system may include a web server associated with a service provider that manages and presents profile monitoring options to the user. In some embodiments, the web server may execute the machine learning model.

The system may be configured to generate and train the machine learning models using historical user data to improve digital profile detection and monitoring. For example, when the received user data includes insufficient data to build a complete digital profile for detecting an instance of the digital user data, the machine learning model may be trained on the historical user data to detect a more complete digital profile of the user. The machine learning model may be configured to extrapolate the received user data to identify additional user data based upon the machine learning model. In this way, the system ensures that each instance of the digital user data stored within a computer environment is detected. The machine learning model may also be trained to conduct automated searches including where to search (e.g., URLs or other locations accessible by computing devices) for instances of the user digital profile data.

In some embodiments, the profile monitoring system may receive user data from multiple sources, including but not limited to emails, text messages, social media platforms, government database, medical database, financial database, insurance database, screen data, and/or other application interactions where user data may be collected and/or stored. Further, the digital profile monitoring system may receive the user data from a plurality of devices associated with the user. For example, the system may receive user data including a social media mention from a first device and a forum post from an additional device.

The user data may be analyzed to determine hints or cues that enable the detection of an instance of a particular digital profile. In various embodiments, multiple profile references and attributes of the user data may define the type of digital profile. For example, the digital profile monitoring system may determine if the instance of the digital profile corresponds to a social media account, personal information, financial information, insurance information, and/or health information. Managing the plurality of instances of the digital profile data and grouping them by common attributes ensures the system can track and manage the entirety of the user’s digital profile.

Further, the profile monitoring system may be programmed to execute the machine learning model to analyze the user data and extract profile indicators such as usernames, links, and/or personal identifiers. The machine learning model may perform keyword searches, pattern recognition, and computer vision techniques, allowing it to identify instances of a digital profile when data is incomplete or scattered. Once the profile type is determined, the system can combine monitoring operations across each of the instances of the digital profile to generate the monitoring plan. Grouping the detected instances of the digital profile data enables consistent profile monitoring by adjusting privacy settings, issuing data removal commands, or encrypting sensitive information across each instance of the detected digital profile.

The profile monitoring system may receive user data from one or more user devices. The detection server may incorporate data analysis modules configured to identify potential profile indicators from the received user data. Static data elements, such as familiar platform-specific terms or standardized profile labels, may be used to structure the recognition process. Dynamic data elements, including usernames, timestamps, social media handles, or contextual metadata, across the plurality of instances.

Identifying static and dynamic elements and understanding their contextual relationships may enable the system to accurately form a structured representation of the detected digital profiles associated with the user data. For example, the received user data may include a social media handle and a post including digital profile information. The system may be configured to identify the social media platform associated with the handle as a static data element and the social media handle as the dynamic data element. Analyzing both the static data elements and the dynamic data elements enables the digital profile monitoring system to improve groupings of the instances of the digital profile data to generate the monitoring plan.

The profile monitoring system may include a machine learning model within the analysis module to improve digital profile detection. For example, the system may detect a digital profile reference without security preferences and may determine suitable monitoring operations.

The monitoring operations may include modifying and/or removing the detected instance of the digital profile from the various computer environments or platforms. For example, the monitoring operation may include computer executable code that, when executed by the platform storing the instance of the digital profile data, masking of personal data or restricting accessibility for the detected instance is caused by the executed code.

Further, the machine learning model may be configured to detect the presence of the digital user profile on additional unrelated accounts. For example, the machine learning program may be configured to determine where the digital user data has been posted beyond the profiles of the user (e.g., posted by another user, copied to an unauthorized profile, or other misuse of the digital profile data).

The machine learning model may train on historical profile data to better recognize correlations and identify additional instances of the user data from incomplete data. Further, the machine learning model can further improve detection of the digital profile based upon continuous refinement through user feedback.

In some embodiments, the machine learning model may interact with an external source to gather additional details about the digital profile of the user. For example, the system may access remote servers to request updates, removal of certain data, receive additional user data, and/or to implement stricter privacy measures. In some embodiments, the system may prompt the user for input, offering them icons or controls that represent specific monitoring operations based upon the generated monitoring plan.

The profile monitoring system may analyze each instance of the digital profile data to determine what monitoring operations to present or execute for the generated monitoring plan. The system may process each of the instances to confirm that multiple instances correspond to the digital profile. Validating the digital profile ensures the generated monitoring plan includes requested monitoring operations (e.g., removal, encryption, or access limitation) are accurately applied to the correct profile. When updates to the user data or the digital profile data are detected, the system may modify the monitoring plan and incorporate the additional data.

The detection of an instance of the digital profile may result in the generation of a monitoring plan. The system begins by analyzing the detected instance to identify its attributes, such as platform type, data source, or profile identifiers. The digital profile monitoring system may then determine one or more monitoring operations, which may include restricting access, issuing removal requests, updating privacy settings, or encrypting sensitive data associated with each of the detected instances. The monitoring operations may be prioritized and organized into a structured plan to ensure consistent application across all related instances of the detected digital profile. The monitoring operations may be carried out by the system generating computer executable instructions that is deployed to the platform or environment storing the instance of the profile data. The instructions are then executed and the monitoring operations are carried out at the platform or environment.

The monitoring plan may include monitoring operations associated with each instance of the detected digital user profile. For example, if the user selection indicates strict privacy, the digital profile monitoring system may enforce encryption, send data removal requests, and update platform settings accordingly. The digital profile monitoring system may include a monitoring plan generation module capable of communicating with user devices and external platforms. The monitoring plan generation module may store and instances of the detected digital profile and apply corresponding monitoring operations. As the system process the user data the generated monitoring plan modifies the monitoring operations (e.g., privacy parameters or access restrictions) are common across each of the identified instances. Centralizing the monitoring plan enables the system to retrieve, update, and execute the monitoring operations based upon the user’s selection.

As the system receives additional user data, the system may identify additional instances of the digital profiles and refine the monitoring plan. The system may determine whether the additional user data matches any existing instances and, if not, determines whether a new monitoring plan should be generated. The monitoring plan may span multiple platforms and use cases, resulting in integrated profile management over conventional, disorganized, approaches. Traditional methods often may rely on manual input or isolated detection, without leveraging machine learning or automated pattern recognition.

Additionally, the profile monitoring system may employ machine learning models to detect missing or sensitive user data. For example, the digital profile and monitoring system may identify incomplete personal identifiers or metadata from the user data. The digital profile monitoring system may then conduct automated searches using the machine learning model to supplement the user data with relevant details, such as retrieving associated usernames or timestamps, or to remove undesired information like outdated posts or unauthorized copies of the user digital profile data. Once digital profiles are confirmed, the digital profile monitoring system may generate, modify, and/or save a monitoring plan aligned with the user’s preferences and selected privacy settings. By implementing these features through sophisticated computing resources, the system reduces manual input and complexity, improves reliability, and enhances overall user control over their digital presence.

The digital profile monitoring systems and method may also include identifying missing data associated with the digital profile from the received user data, and may then utilize the machine learning models to cause an automated search to be conducted for additional data to supplement the user data. The digital profile monitoring system may then generate a digital profile monitoring plan that includes the user data and the supplement data that may be then saved in a centralized location with the data stored in a common format. The methods and systems described herein may be implemented using computer programming or engineering techniques including computer software, firmware, hardware, or any combination or subset thereof.

The disclosed systems and methods for digital profile monitoring may also identify missing profile attributes associated with the digital user profile data obtained from the user. The system may execute the machine learning models to conduct automated searches to identify additional user data. Once the additional user data is processed by the profile monitoring system, the system may generate a monitoring plan incorporating instances of the digital profile associated with the user data and the additional user data. The digital profile monitoring system may be stored in a centralized database, allowing the digital profile information and monitoring plan to be maintained in a consistent, accessible format. These processes may be implemented using computer programming or engineering approaches, including computer software, firmware, hardware, or any combination thereof.

### EXEMPLARY DIGITAL PROFILE MONITORING SYSTEM

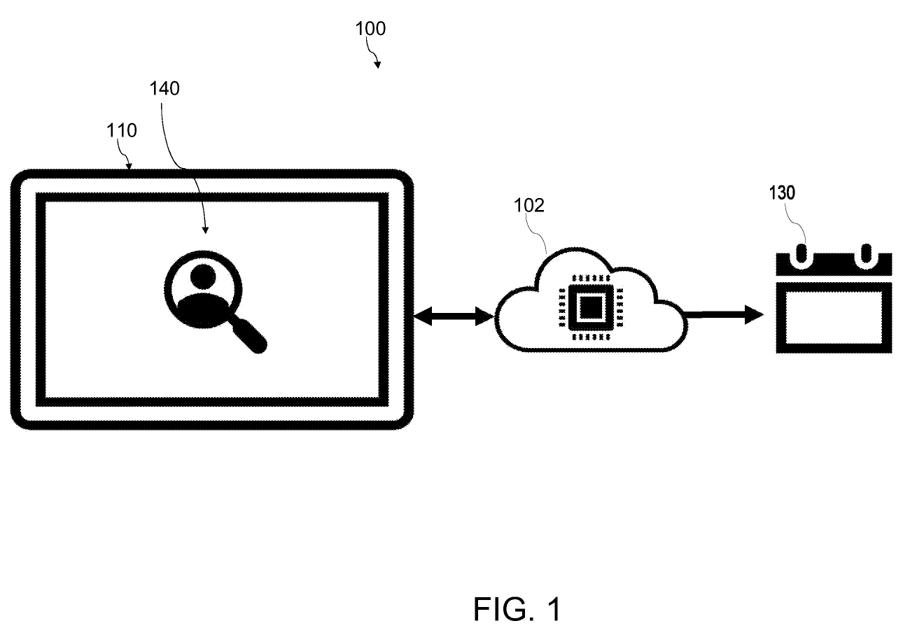

FIG. 1 illustrates an example embodiment of a digital profile monitoring system 100 as further described herein. The digital profile monitoring system 100 may include one or more user devices 110 and one or more external databases 130. In some embodiments, the external databases may be accessed by the digital profile system 100. The digital profile monitoring system 100 includes a digital profile monitoring server 102 in communication with the one or more user devices 110 and databases 130. A user device 110 may be associated with a user who interacts through a user interface on the user device 110 to provide user data indicative of digital profiles or related attributes to the digital profile monitoring system 100.

In various embodiments, the profile monitoring system 100 may continuously monitor user devices 110 to capture user data 140 or may receive user data 140 from user devices 110. For example, when user data that may correspond to a potential instance of a digital user profile is detected based upon the received user data, the user device 110 may prompt the user, via instructions sent by the digital profile monitoring server 102, to confirm the instance of the digital profile and manage the detected user digital profile data 140 using the generated monitoring plan generated by the digital profile monitoring system 100. The user devices 110 may include software or web applications enabling them to communicate over various networks to receive the user data and/or detect the instances of the digital profiles. The digital profile monitoring server 102 may be configured to locate the instances of the user’s digital profile stored within a computer environment, and communicate with the user devices 110 to facilitate developing the monitoring plan. The networks may include the Internet, local area networks, wide area networks, or cellular connections. These user devices 110 may include smartphones, tablets, laptops, wearable electronics, and/or other devices capable of accessing the digital profile monitoring system 100.

The profile monitoring system 100 may also be connected to at least one database or data source 130 configured to store or provide the user data 140. The profile monitoring system 100, and more specifically, the digital profile monitoring server 102, may receive user data from either the user device 110 and/or the data source 130 to detect the instance of the user’s digital profile. In various embodiments, the data source 130 may include a database server and a database connected to the profile monitoring system 100. The data source 130 may store the user data, the digital profile data, the instances of detected digital profiles, the generated monitoring plans, and/or a dashboard associated with the digital profile monitoring system 100. In various embodiments, the dashboard may be displayed on an application displayed on the user device 110. Further, the data source 130 may be configured to include scalable storage solutions, handle fault tolerance, and/or include data security capabilities to execute the generated profile monitoring plan.

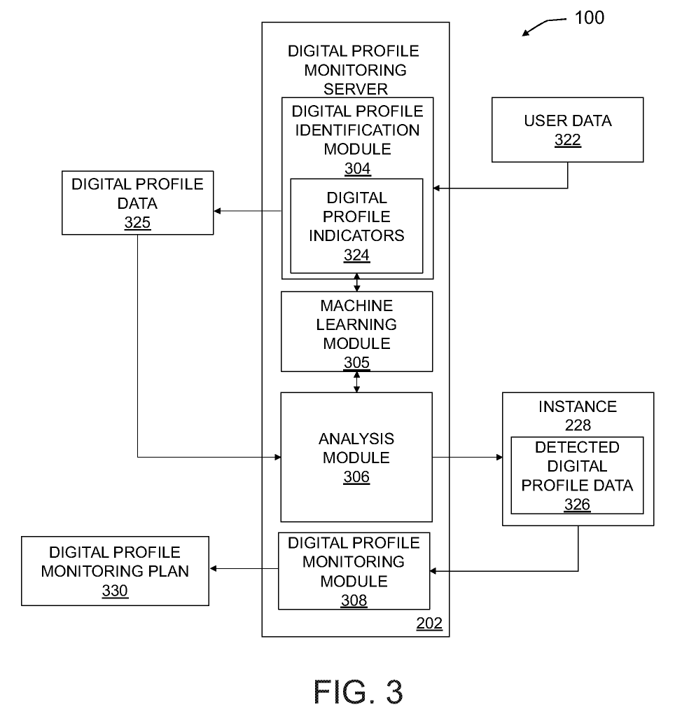

The digital profile monitoring system 100, and more specifically, the digital profile monitoring server 102, may further include various modules (e.g., digital profile identification module 304, machine learning model 305, analysis module 306, and/or digital profile monitoring module 308 all shown in FIG. 3) that may be executed to process and analyze user data 140 to monitor for the instances of the digital profiles. For example, the digital profile identification module 304 may receive user data 322, which may include unstructured user data, and execute the machine learning model to parse and extract digital profile indicators from the user data. For instance, the machine learning module 305 may execute machine learning methods to detect profile indicators from usernames, links, or incomplete references to a digital presence from the user data 322 (shown in FIG. 3).

Further, the machine learning module 305 may processes the digital profile indicators 324 to identify an instance of the digital profile. The digital profile identification module 304 may extract user digital profile data from the detected instance and process the digital user data using the analysis module 306. The analysis module 306 may be configured to compare and correlate each of the detected instances that may be included in the digital profile monitoring plan 330. By identifying and matching substantially similar instances of a digital profile, the analysis module 306 may group related digital profile instances and combine them for the digital profile monitoring plan.

The digital profile monitoring system 100 may be configured to identify additional user data. For example, the machine learning module 305 may generate the additional user data to supplement the received user data to improve digital profile detection. The machine learning model of the machine learning module 305 may be trained on historical user data and external sources to supplement the received user data 322 with personal identifiers, or digital profile data associated with the user. For example, the digital profile monitoring system may generate additional user data based upon the digital user data associated with the detected instances to improve the representation of the user’s online presence. In some embodiments, the machine learning model may identify missing components, search associated data sources, and produce enriched information to ensure each instance of a digital profile of the user is detected within the computer network environment.

In various embodiments, the machine learning module 305 may determine one or more monitoring operations to schedule and execute monitoring actions across the detected instances of the digital profiles. Each monitoring operation may include one or more monitoring actions associated with modifying the digital user data in the at least one detected instance. For example, upon identification of an instance of the user’s digital profile, the digital profile monitoring system 100 may generate monitoring operations to remove the digital user data, update privacy settings for the at least one instance, encrypt the digital user data, or generate removal requests (or cause the data to be removed) from one or more external platforms. In some embodiments, the system may group multiple instances associated with the same or substantially similar digital profiles for batch operations, allowing uniform data updates or removals across each instance.

Furthermore, the machine learning module 305 may process user-defined criteria to classify the digital profile data and apply the corresponding monitoring operations associated with the profile monitoring plan. For example, the user may define a rule for removing personal identifiers from public sources, and the machine learning module 305 may be configured to deploy the user defined rule causing the user data to be removed or deleted from the public sources.

When the profile monitoring system generates the monitoring plan, a monitoring operation of the monitoring plan may initiate a removal request or restrict access to the associated digital user data. The digital profile monitoring system 100 may process feedback from the user associated with the completed monitoring operations to refine future monitoring plans. In some embodiments, the digital profile monitoring system 100 may update monitoring operations for new instances of the user digital profile data or changes to existing user digital profile data. The monitoring operations may include detecting previously removed data or new sensitive data associated with the detected instance. In various embodiments, the digital profile monitoring system 100 may generate additional monitoring operations and prompt the user to confirm or reject them.

In various embodiments, the digital profile monitoring system 100 may generate a monitoring plan for the detected instances of the digital profile by processing user selections and rules. The digital profile monitoring system 100 may receive a user selection to execute monitoring operations (e.g., removing the user digital profile data or limiting access), the digital profile monitoring system 100 compiles these selections to generate the monitoring plan that outlines the monitoring operations to execute for each detected instance of the digital profile. For example, the user may specify to restrict all instances of a personal identifier, the digital profile monitoring system 100 may then create a monitoring plan that includes monitoring operations to flag content matching that identifier for access controls or removal.

In the exemplary embodiment, the generated monitoring plan may specify the scope (e.g., the digital profiles, platforms, or the user digital profile data types affected) and the schedule for executing each monitoring operation of the monitoring plan. The generated monitoring plan may be stored in the digital profile monitoring system 100. The digital profile monitoring system 100 may initiate the monitoring operations in an automated or user-confirmed sequence. The digital profile monitoring system 100 may process user feedback of the generated monitoring plan to incorporate into the monitoring plan’s parameters to refine the monitoring plan.

In various embodiments, the digital profile monitoring system 100 may generate the digital profile monitoring plan based upon the detected instances of the digital profile. The digital profile monitoring module 308 may integrate the detected instances into a monitoring plan including a plurality of monitoring operations. In various embodiments, the monitoring operations may be determined based upon the detected instances of the user digital profile data 326. In various embodiments, each of the monitoring operations may be stored in the centralized database and presented on a dashboard application associated with the generated monitoring plan. The dashboard enables the user to view, manage, and/or modify the monitoring operations across multiple instances of the detected digital profile for each of the generated monitoring plans.

### EXEMPLARY DIGITAL PROFILE MONITORING SYSTEM

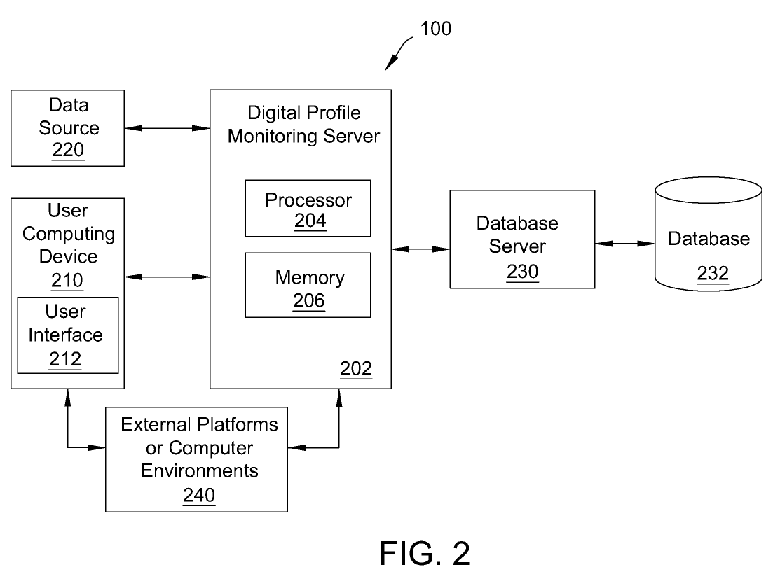

FIG. 2 illustrates a more detailed exemplary embodiment of the digital profile monitoring system 100, that is also shown in FIG. 1. The digital profile monitoring system 100 may include one or more user devices 210 and one or more data sources 220. In some embodiments, the database server 230 and associated database 232 may be accessed by the digital profile monitoring system 100. FIG. 2 also includes a digital profile monitoring server 202 that is similar to the server 102 shown in FIG. 1. The digital profile monitoring server 202 may include at least one processor 204 and at least one memory device 206 for storing computer instructions and/or other data.

The digital profile monitoring server 202 is in communication with the one or more user devices 210 and/or data sources 220. The user device 210 may be associated with a user who interacts through a user interface 212 on the user device 210 to provide user data indicative of digital profiles or related attributes to the digital profile monitoring system 100.

In various embodiments, the digital profile monitoring system 100 may continuously monitor user devices 210 to capture or receive user data. For example, when user data that may correspond to a potential instance of a digital user profile is detected, the user device 210 may prompt the user to confirm the instance of the digital profile and manage the detected user digital profile data using the generated monitoring plan from the digital profile monitoring system 100.

The user device 210 may include software or web applications enabling them to communicate over various networks to receive the user data and/or detect the instances of the digital profiles. The networks may include the Internet, local area networks, wide area networks, or cellular connections. These user devices 210 may include smartphones, tablets, laptops, wearable electronics, and/or other devices capable of accessing the digital profile monitoring system 100.

The digital profile monitoring system 100 may also be connected to at least one data source 220 configured to store or provide user data. The digital profile monitoring system 100 may receive user data from both the user device 210 and the data source 220 to detect the instances of the digital profile. In the example embodiment, the digital profile monitoring server 202 may be in further communication with a database server 230 and a database 232 for storing data such as computer instructions, monitoring plans, detected instances of located digital profiles, dashboards, etc.

The data source 220 may store the user data that is needed to develop the digital profile data that is used to locate the instances of detected digital profiles and generate the monitoring plans, and/or dashboards associated with the digital profile monitoring system 100 that may then be stored within database 232. In certain embodiments, the dashboard may be displayed on an interface displayed on the user device 210. Further, the database 232 may be configured to include scalable storage solutions, handle fault tolerance, and/or include data security capabilities to execute the generated profile monitoring plan.

In various embodiments, the digital profile monitoring system 100 may generate a monitoring plan for the detected instances of the digital profile by processing user selections and rules. The digital profile monitoring system 100 may receive a user selection from the user device to determine one or more monitoring operations (e.g., removing the user digital profile data or limiting access). The digital profile monitoring server 202 may also be in communication with external platforms and/or computer network environments 240. The external platforms 240 may include a variety of different computer environments including social media platforms, websites, news sites, merchant online locations, purchasing sites, financial sites, healthcare sites, etc. and any other online locations that may store and/or process instances of a user’s digital profile data. In addition, the user computing devices 210 may also be in communication with the external platforms 240, and may exchange data with the various sites included within the external platforms 240. Thus, the user data may be shared or communicated to external platforms 240 such that the various instances of profile data may then be stored within the external platforms 240. The digital profile monitoring server 202 is configured to receive the user data from the user computing device 210 or the data source 220, and then build the user digital profiles so that the server 202 is then able to search the external platforms 240 for the instances of profile data and apply the monitoring operations.

The digital profile monitoring system 100 may determine the monitoring operations based upon the user selection to generate the monitoring plan for each detected instance of the digital profile. For example, the user may specify to restrict all instances of a personal identifier, and the digital profile monitoring system 100 may then determine one or more monitoring operations associated with the user selection and generate the monitoring plan to flag content matching that identifier for access controls or removal.

In the exemplary embodiment, the generated monitoring plan may specify the scope (e.g., the digital profiles, platforms, or the user digital profile data types affected) and the schedule for executing each monitoring operation of the monitoring plan on the external platforms 240. The generated monitoring plan may be stored in the digital profile monitoring system 100. The digital profile monitoring system 100 may initiate the monitoring operations in an automated or user-determined sequence. The digital profile monitoring system 100 may receive user feedback of the generated monitoring plan to incorporate into the monitoring plan’s parameters to refine the monitoring plan.

In various embodiments, the digital profile monitoring system 100 may generate the digital profile monitoring plan based upon the detected instances of the digital profile. The digital profile monitoring module 308 may integrate the detected instances into a monitoring plan including a plurality of monitoring operations. In various embodiments, the monitoring operations may be determined based upon the detected instances of the user digital profile data. In certain embodiments, each of the monitoring operations may be stored in the centralized database and presented on a dashboard application associated with the generated monitoring plan. The dashboard may enable the user to view, listen to, manage, and/or modify the monitoring operations across multiple instances of the detected digital profile for each of the generated monitoring plans.

### EXEMPLARY DIGITAL PROFILE MONITORING SERVER

FIG. 3 illustrates a simplified block diagram of an exemplary digital profile monitoring computer system 100 that may be connected to one or more user devices equipped with user interfaces. Each user device may be associated with a particular individual who provides the user data 322 to the digital profile monitoring server 202. When the digital profile monitoring server 202 detects digital profile indicators 324 included within the received user data, the server 202 is configured to generate or identify a digital profile and/or user digital profile data 325 related to attributes from the received user data 322. The user device may prompt the user to confirm, update, or manage the detected digital profile data 325 in response to the user device being prompted via instructions sent by the profile monitoring server 202. Once the digital profile 325 is built, the server 202 uses that digital profile data 325 of the user to search for instances 228 of the digital profile data stored within the external platforms 240 to create detected digital profile data 326. The user devices may access the profile monitoring server 202 over various network connections and may include desktop computers, laptops, smartphones, tablets, wearable electronics, or any device capable of interacting with remote servers and applications. The user devices may then review the detected digital profile data 326 and manage these instances 228 of data by applying monitoring operations of a monitoring plan 330 to the instances 228.

The digital profile monitoring server 202 may also communicate with at least one data source of user data 322 capable of supplying unstructured digital user data. The server 202 may receive data directly from these data sources 220 or from the user devices 210. The profile monitoring server 202 can store, process, and deliver webpages or other interfaces that present management options for the detected digital profiles. The user data 322, including references to various digital profiles and their attributes, may be transmitted to a database server for processing and storage.

The database may store an organized collection of digital profile data 324, including instances of identified profiles, supplemental attributes, monitoring operations, and any additional information associated with the detected online presence. This database may employ scalable storage, fault tolerance, and integrated security capabilities. Users may remotely access this centralized repository through their computing devices after connecting to the profile monitoring server.

The profile monitoring server 202 may include various modules that work together to identify, analyze, and generate meaningful structures from the user data. An identification module may receive raw, potentially unstructured user data from the data sources or user devices. A computer vision module and a machine learning module 305 may then process this data to extract indicators 324 of digital profiles, such as usernames or partial profile descriptions. The profile monitoring server 202 may then build the digital profiles including digital profile data 325 from the received user data 322 for a user, and then search the external platforms 240 for instances 228 of the user digital profile data 325 stored therein. In other words, through these modules, the system 100 identifies instances 228 of the user’s digital profile 326 stored within the external platforms 240 for further monitoring and applying monitoring actions.

The digital profile monitoring system 100 may include various modules (e.g., digital profile identification module 304, machine learning model 305, analysis module 306, and/or digital profile monitoring module 308) that may be executed to process and analyze user data 322 to monitor for the instances 228 of the detected digital profiles 326. For example, the digital profile identification module 304 may receive user data 322, which may include unstructured user data, and execute the machine learning model 305 to parse and extract digital profile indicators 324 from the user data 322. The machine learning model 305 may execute machine learning methods to detect profile indicators 324 such as usernames, links, or incomplete references to a digital presence from the user data 322. Further, the machine learning model 305 may process the profile indicators 324 to build the digital profile data 325, which is then used by the server 202 to identify one or more instance 228 of a detected digital profile 326. The digital profile identification module 304 may extract user digital profile data from the detected instance 228 and process the digital user data using the analysis module 306. The analysis module 306 may be configured to compare and correlate each of the detected instances 326 that may be included in the digital profile monitoring plan 330. By identifying matching or substantially similar instances of a digital profile, the analysis module 306 may group related digital profile instances and combine them for the digital profile monitoring plan.

The digital profile monitoring system 100 may be configured to identify additional user data 322. For example, the machine learning model 305 may generate additional user data 322 to supplement the received user data 322 and improve digital profile detection. The machine learning model 305 may be trained on historical user data and external sources to supplement the received user data 322 with personal identifiers or digital profile data associated with the user. For example, the digital profile monitoring system 100 may generate additional user data based upon the received digital user data 322 associated with the detected instances 228 to improve the representation of the user’s online presence. In some embodiments, the machine learning model may identify missing components, search associated data sources, and produce enriched information to ensure each instance of a digital profile is detected.

In various embodiments, the machine learning model 305 may determine one or more monitoring operations 330 to schedule and execute monitoring actions across the detected instances of digital profiles. Each monitoring operation may include one or more monitoring actions associated with modifying the digital user data in the at least one detected instance 326. For example, upon identification of an instance of the digital profile 326, the digital profile monitoring system 100 may generate monitoring operations to remove the digital user data, update privacy settings for the at least one instance, encrypt the digital user data, or generate removal requests from one or more external platforms. In some embodiments, the system may group multiple instances associated with the same or substantially similar digital profiles for batch operations, allowing uniform data updates or removals across each instance.

Further, the machine learning model 305 may process user-defined criteria to classify the digital profile data 325 and apply the corresponding monitoring operations associated with the profile monitoring plan 330. For example, the user may define a rule for removing personal identifiers from public sources. When the profile monitoring system 100 generates the monitoring plan 330, a monitoring operation of the monitoring plan 330 may initiate a removal request or restrict access to the associated digital user data. The digital profile monitoring system 100 may process feedback from the user associated with the completed monitoring operations to refine future monitoring plans. The digital profile monitoring server 202 is configured to deploy computer instructions, that may be executed by a user device or an external platform 240, to cause the monitoring operations of the monitoring plan 330 to be carried out at the user device or the external platform 240. In other words, if a detected digital profile 326 is located at an external platform 240, and the monitoring plan 330 requires the detected digital profile 326 to be deleted or removed from the external platform 240, instructions will be sent by server 202 to cause that operation action to be carried out. Similarly, other operation actions may be carried out that way.

In some embodiments, the digital profile monitoring system 100 may update monitoring operations for new instances of the user digital profile data or changes to existing user digital profile data. The monitoring operations may include detecting previously removed data or new sensitive data associated with the detected instance. In various embodiments, the digital profile monitoring system 100 may generate additional monitoring operations and prompt the user to confirm or reject them.

The analysis module 306 refines and correlates these detected 326 instances 228, comparing them to existing digital profile records 325. By identifying matches or partial matches between profile attributes, the analysis module 306 may consolidate multiple instances into a single, unified digital profile. Should incomplete data be detected, such as partial profile information lacking key details, the machine learning module 305 may search external data sources and supplement the user data with additional attributes. These may include missing identifiers, platform-specific links, or other data necessary to form a comprehensive digital profile representation.

### EXEMPLARY COMPUTER NETWORK

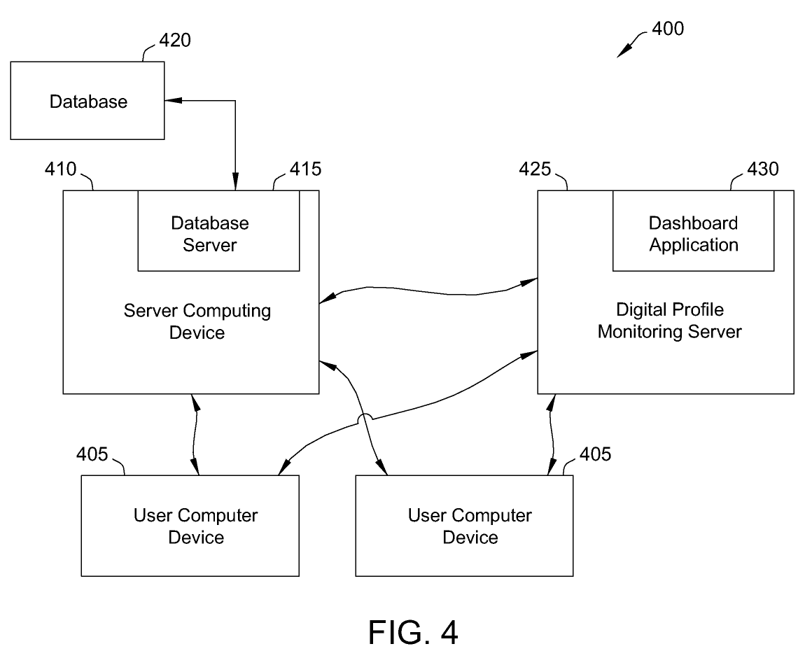

FIG. 4 depicts a simplified block diagram of an exemplary computer system 400. In the exemplary embodiment, system 400 may be used for providing a digital profile monitoring plan. The user computer devices 405 may be computers that include a web browser or a software application, which may enable client computer devices 405 to access server computing device 410 using the Internet. More specifically, user computer devices 405 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computer devices 405 may be a computer device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), smart glasses, a kiosk, a drone, chat bots, or other web-based connectable equipment or mobile devices.

A database server 415 may be communicatively coupled to a database 420 that stores data. In one embodiment, database 420 may include digital profile data, user information, and/or user preferences. In the exemplary embodiment, database 420 may be stored remotely from server computing device 410 and/or digital profile monitoring server 425. In some embodiments, database 420 may be decentralized. In the exemplary embodiment, a person may access database 420 via client computer devices 405 by logging onto server computing device 410 and/or digital profile monitoring server 425, as described herein.

Server computing device 410 may be communicatively coupled with one or more the client computer devices 405. In some embodiments, server computing device 410 may be associated with or may be part of a computer network associated with an organization (e.g., business, group, school, team, or other user associated network) or in communication with the organization’s computer network. In other embodiments, server computing device 410 may be associated with a third party and is merely in communication with the organizations’ computer network. One or more digital profile monitoring servers 425 may be communicatively coupled with server computing device 410. The one or more digital profile monitoring servers 425 each may be associated with a dashboard application 430. Digital profile monitoring servers 425 may provide tools and/or applications for users to access their associated dashboard application 430 over the Internet.

In the exemplary embodiment, server computing device 410 and/or digital profile monitoring server 425 may communicate with a user device (e.g., user computer device 405) to cause the user device to present an indication of a detected digital profile. Server computing device 410 and/or digital profile monitoring server 425 may provide an indication including digital profile data, additional digital profile data, or other instances of the detected digital profile that may be presented to the user by the user device. Server computing device 410 and/or digital profile monitoring server 425 may receive user input data from the user device, and based upon this received user input data, server computing device 410 and/or digital profile monitoring server 425 may continually update the dashboard application 430. For example, the system may respond to the input of the user.

In the exemplary embodiment, server computing device 410 may generate a proposed response to a user based upon received user input data. User input that indicates a response may be required may include questions input by the user. For example, if the user inputs additional digital profile data, server computing device 410 may determine an update to the digital profile on the digital profile monitoring plan. In some embodiments, user inputs may include actions from the user device, such as sending emails, phone messages, screen data, and/or text messages of the user.

In the exemplary embodiment, server computing device 410 may provide for a secure exchange of digital profile data using a digital profile monitoring mechanism. The digital profile monitoring plan may enable a user to securely store digital profile data and to authorize other users to access the digital profile data. For example, a user may, through input designate digital profile data to be stored in the digital profile monitoring plan, or the digital profile data may automatically be stored in association with the digital profile monitoring plan in response to certain digital profile data.

The user may also designate other users to access the digital profile data, or server computing device 410 may determine which individuals to authorize access to the digital profile data stored within the digital profile monitoring plan. These authorized users may than retrieve, view, and/or trigger a download of the digital profile data, for example, by accessing the digital profile monitoring plan on an additional user computer device.

### EXEMPLARY USER DEVICE

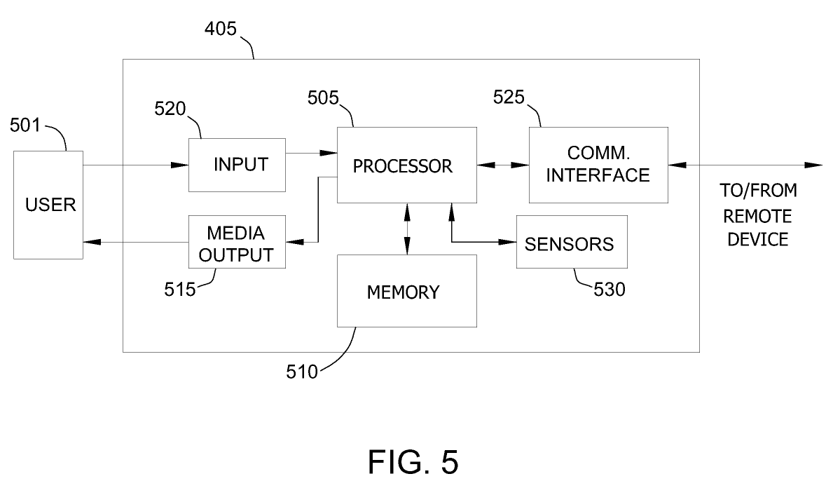

FIG. 5 depicts an exemplary configuration of a user computer device 405 shown in FIG. 4, in accordance with one embodiment of the present disclosure. User computing device 405 may be operated by a user 501. User computing device 405 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computing device 405 may also include at least one media output component 515 for presenting information to user 401. Media output component 515 may be any component capable of conveying information to user 501 regarding the digital profile data. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display), an audio output device (e.g., a speaker or headphones), or other display devices.

Input device 520 may include, for example, a keyboard, a pointing device, a mouse, a stylus, a touch sensitive panel (e.g., a touch pad or a touch screen), a gyroscope, an accelerometer, a position detector, a biometric input device, an audio input device (e.g., a microphone), a voice bot or chatbot, and/or a video input device (e.g., a camera). A single component such as a touch screen may function as both an output device of media output component 515 and input device 520.

User computing device 405 may also include a communication interface 525, communicatively coupled to a remote device such as server computing device 410 (shown in FIG. 4). Communication interface 525 may include, for example, a wired or wireless network adapter and/or a wireless data transceiver for use with a mobile telecommunications network.

Stored in memory area 510 may be, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from the server computing device 410 and/or the digital profile monitoring server 425.

A client application allows user 501 to interact with, for example, the server computing device 410 and/or the digital profile monitoring server 425. For example, instructions may be stored by a cloud service, and the output of the execution of the instructions sent to the media output component 515. Processor 505 executes computer-executable instructions for implementing aspects of the disclosure. In some embodiments, the processor 505 is transformed into a special purpose microprocessor by executing computer-executable instructions or by otherwise being programmed.

### EXEMPLARY SERVER DEVICE

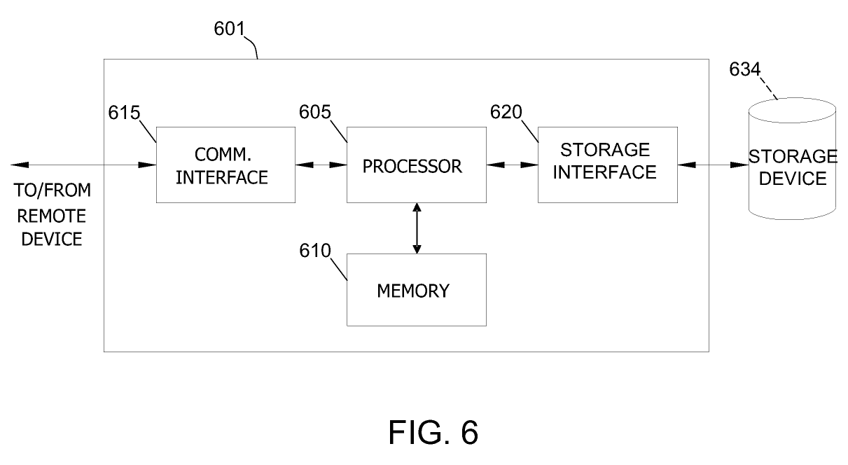

FIG. 6 depicts an exemplary configuration of a server computing device 601, in accordance with one embodiment of the present disclosure. Server computer device 601 may include, but is not limited to, server computing device 410 and/or digital profile monitoring server 425 (all shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, digital profile monitoring server 425, or user devices 405 (shown in FIGS. 4 and 5). For example, communication interface 615 may receive requests from client computer devices 405 via the Internet.

Processor 605 may also be operatively coupled to a storage device 634. Storage device 634 may be any computer-operated hardware suitable for storing and/or retrieving data, such as, but not limited to, data associated with database 420 (shown in FIG. 4). In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 434.

Processor 605 may execute computer-executable instructions for implementing aspects of the disclosure. In some embodiments, the processor 605 may be transformed into a special purpose microprocessor by executing computer-executable instructions or by otherwise being programmed.

### EXEMPLARY COMPUTER-IMPLEMENTED METHOD FOR GENERATING A DIGITAL PROFILE MONITORING PLAN

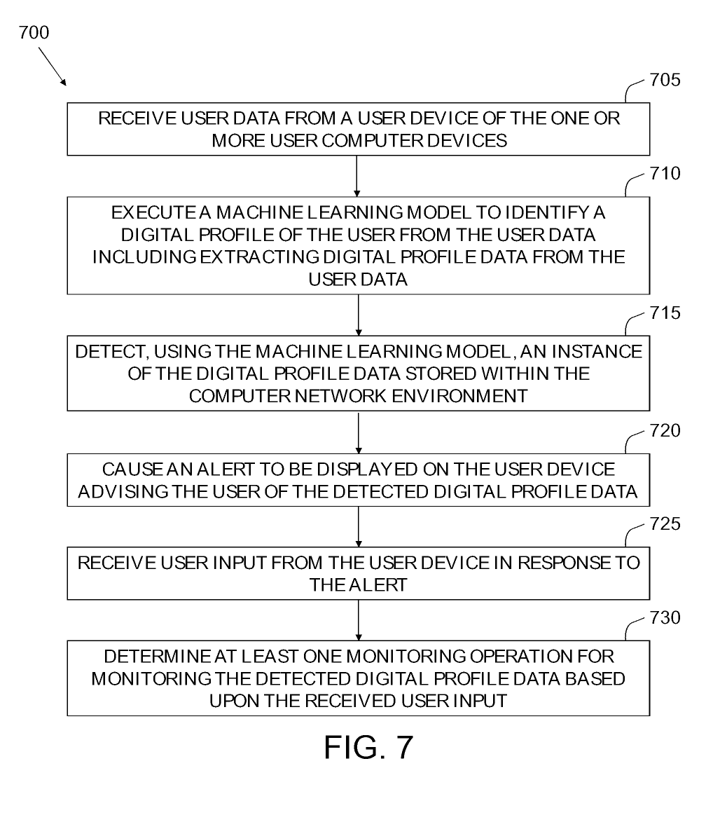

FIG. 7 depicts a flow chart of an exemplary computer-implemented process 700 for generating a digital profile monitoring plan and implementing monitoring actions using the system 100 shown in FIG. 1. Process 700 may be implemented by a computing device, for example server computing device 410 and/or digital monitoring server 425. In the exemplary embodiment, server computing device 410 may be in communication with one or more digital profile monitoring servers 425 and one or more client computer devices 405 (both shown in FIG. 4).

In the example embodiment, process 700 may include receiving 705 user data from a user device of the one or more user computer devices. Process 700 may further include executing 710 a machine learning model to identify a digital profile of the user from the received user data including extracting digital profile data from the user data. The process 700 may also include detecting 715, using the machine learning model, an instance of the digital profile data stored within a computer network environment and/or external platforms. Process 700 may further include causing 720 an alert to be displayed on the user device advising the user of the detected instance of digital profile data. Process 700 may also include receiving 725 user input from the user device in response to the alert. Process 700 may further include determining 730 at least one monitoring operation for monitoring the detected digital profile data based upon the received user input. As described herein, the monitoring operations may include transmitting instructions to the computer network environment and/or external platforms that cause the detected digital profile data to be masked, deleted, anonymized, and/or restricted in some way to protect the digital profile data from being exposed to persons that the user would prefer the data to not be exposed to.

### EXEMPLARY EMBODIMENTS & FUNCTIONALITY

In one aspect, a computer system for generating and/or implementing digital profile monitoring plans may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, machine learning models, ChatGPT or ChatGPT-based bots, generative AI-based bots, and/or other electronic or electrical components, which may be in wired or wireless communication with one another, and operate as input and/or output devices. For example, in one instance, the computer system may include at least one processor and/or associated transceiver in communication with at least one memory device and in communication with a user device associated with a user The at least one processor may be programmed to: (1) receive user data from a user device of the one or more user computer devices, (2) execute a machine learning model to identify a digital profile of the user from the received user data including extracting digital profile data from the user data, (3) detect, using the machine learning model, an instance of the digital profile data stored within a computer network environment and/or external platform, (4) cause an alert to be displayed on the user device advising the user of the detected digital profile data, (5) receive user input from the user device in response to the alert; and/or (6) determine at least one monitoring operation for monitoring the detected digital profile data based upon the received user input. The computer system may have additional, less, or alternate functionality, including that discussed elsewhere herein.

In another aspect, a computer-implemented method for generating and/or implementing digital profile monitoring plans. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, machine learning models, ChatGPT or ChatGPT-based bots, and/or other electronic or electrical components, which may be in wired or wireless communication with one another, and operate as input and/or output devices. For example, in one instance, the computer-implemented method may be implemented by a computer system including at least one processor and/or associated transceiver in communication with at least one memory device and in communication with a user device associated with a user. The method may include: (1) receiving user data from a user device of the one or more user computer devices, (2) executing a machine learning model to identify a digital profile of the user from the received user data including extracting digital profile data from the user data, (3) detecting, using the machine learning model, an instance of the digital profile data stored within a computer network environment and/or external platform, (4) causing an alert to be displayed on the user device advising the user of the detected digital profile data, (5) receiving user input from the user device in response to the alert; and/or (6) determining at least one monitoring operation for monitoring the detected digital profile data based upon the received user input. The computer-executable instructions may direct additional, less, or alternate functionality, including that discussed elsewhere herein.

In another aspect, a computer system for detecting and monitoring a digital profile of a user within a computer network environment is provided. The computer system includes at least one memory device, and at least one processor in communication with the at least one memory device and with one or more user computer devices. The at least one processor is programmed to: (i) receive user data from a user device of the one or more user computer devices; (ii) execute a machine learning model to identify a digital profile of the user from the received user data including extracting digital profile data from the received user data; (iii) detect, using the machine learning model and the identified digital profile of the user, an instance of the digital profile data stored within the computer network environment; (iv) cause an alert to be displayed on the user device advising the user of the detected instance of the digital profile data; (v) receive user input from the user device in response to the alert; and (vi) determine at least one monitoring operation for monitoring the detected instance of the digital profile data based upon the received user input.

In another embodiment, the computer system described above with any combination of the features described herein may further include the at least one processor being further programmed to cause the alert to be displayed on the user device by transmitting, to the user device, executable instructions that cause a plurality of icons to be displayed on the user device, wherein each icon is associated with a monitoring operation for the detected instance of the digital profile data.

In another embodiment, the computer system described above with any combination of the features described herein may further include the at least one processor being further programmed to receive user input from the user device including at least one icon selected by the user and associated with one of the monitoring operations.

In another embodiment, the computer system described above with any combination of the features described herein may further include the at least one processor being further programmed to implement the monitoring operation associated with the at least one icon selected by the user.

In another embodiment, the computer system described above with any combination of the features described herein may further include the at least one processor being further programmed to generate a monitoring plan for monitoring the detected instance of the digital profile data for the user, the monitoring plan including the one or more monitoring operations executed by the machine learning model and in response to the at least one icon selected by the user. The ML model being trained on historical data for identifying operations that a selected user may desire to be implemented to protect their profile data, and for being configured to implement the monitoring operations including deploying computer instructions for controlling the profile data (e.g., masking, deleting, securing, etc.) at the external platforms.

In another embodiment, the computer system described above with any combination of the features described herein may further include the at least one processor being further programmed to execute the one or more monitoring operations associated with the monitoring plan.

In another embodiment, the computer system described above with any combination of the features described herein may further include the at least one processor being further programmed to cause a report representing one or more results of the one or more monitoring operations associated with the monitoring plan to be displayed on the user device. In other words, the computer system is configured to monitor or track each monitoring operation performed or caused to be performed at the external platform, and report those operations so that the user is able to see what steps have been taken to address the instances of digital profile data.

In another embodiment, the computer system described above with any combination of the features described herein may further include wherein each of the one or more monitoring operations comprises at least one of: remove the detected instance of the digital profile data; restrict access to the detected instance of the digital profile data; obfuscate or mask the digital profile data of the detected instance; or encrypt the digital profile data of the detected instance. These steps help to secure the user’s data on the external platforms, and secure it in a way that the user selects. The choice of how to secure the data is left up to the person the data relates to.

In another embodiment, the computer system described above with any combination of the features described herein may further include the at least one processor being further programmed to: analyze the detected instance of the digital profile data using a natural language processing model to detect sensitive data; encrypt at least a portion of the instance of the digital profile data; and cause the encrypted digital profile data of the user to overwrite the detected instance of the digital profile data stored within the computer network environment. In the example embodiment, natural language processing in combination with the ML model may analyze the user data received by the system so as to determine digital profile data (e.g., certain select data elements) of the user from the received user data.

In another embodiment, the computer system described above with any combination of the features described herein may further include the at least one processor being further programmed to: analyze the detected instance of the digital profile data using a natural language processing model to detect sensitive data; update the instance of the digital profile by removing the sensitive data from the instance of the digital profile; and cause the updated digital profile to replace the detected instance of the digital profile data stored within the computer network environment.

In another embodiment, the computer system described above with any combination of the features described herein may further include the at least one processor being further programmed to: cause a plurality of icons to be displayed on the user device, wherein each icon is associated with a monitoring operation for the detected instance of the digital profile data including a predefined privacy setting, each privacy setting corresponding to a level of data accessibility, wherein the user selection of an icon automatically adjusts the level of the data accessibility for the digital profile data.

In another embodiment, the computer system described above with any combination of the features described herein may further include the at least one processor being further programmed to: remove the detected digital profile data by transmitting a data removal command to at least one remote platform or repository included within the computer network environment, wherein the data removal command includes executable instructions for causing deletion, masking, or anonymization of the digital profile data.

In another embodiment, the computer system described above with any combination of the features described herein may further include wherein the data removal command further includes executable instructions for causing a message to be presented to an administrator of the remote platform or repository to ensure permanent removal of the detected digital profile data.

In another embodiment, the computer system described above with any combination of the features described herein may further include the at least one processor being further programmed to: analyze an external data source for additional user data; update the digital profile data of the digital profile of the user based upon the additional user data; identify an additional instance of the digital profile data within the computer network environment based upon the updated digital profile data of the digital profile, and modify the at least one monitoring operation to incorporate the additional instance of the digital profile data.

In another embodiment, the computer system described above with any combination of the features described herein may further include the at least one processor being further programmed to: generate a monitoring plan including one or more monitoring operations; generate one or more parameters associated with the execution of the one or more monitoring operations of the monitoring plan; and implement the one or more monitoring operations based upon the one or more parameters, wherein the one or more parameters include at least one of: (i) a time interval for attempting to detect an additional instance of the digital profile data; (ii) a retention policy indicating how long the digital profile data or monitoring results are stored; and (iii) a trigger condition for additional monitoring operations or expanded data searches.

In another embodiment, the computer system described above with any combination of the features described herein may further include the at least one processor being further programmed to generate a monitoring plan including one or more monitoring operations, the monitoring plan based upon user input received from the user device, wherein the user input includes selecting a desired privacy threshold for the user, specifying an instance of a digital profile data to monitor, or adjusting parameters of the monitoring operations.

In another embodiment, the computer system described above with any combination of the features described herein may further include the at least one processor being further programmed to: use the machine learning model to detect one or more instances of the digital profile data including one or more compromised passwords of the user; and cause any online accounts associated with the one or more compromised passwords to be closed. This system may be able to determine these passwords from the received user data by either requesting historical passwords used by the user, or by identifying potential passwords of the user from other known passwords and via the ML model that may identify such passwords based thereon.

In another embodiment, the computer system described above with any combination of the features described herein may further include the at least one processor being further programmed to: use the machine learning model to detect one or more instances of the digital profile data including an email address of the user subscribed to one or more websites; and cause the email address to be unsubscribed to the one or more websites.

In another embodiment, the computer system described above with any combination of the features described herein may further include the at least one processor being further programmed to: receive the user data from the user device including biometric data of the user or facial recognition data of the user; and execute the machine learning model to identify a digital profile of the user including digital profile biometric data of the user or digital profile images of the user.

In another embodiment, the computer system described above with any combination of the features described herein may further include the at least one processor being further programmed to: in response to identifying the digital profile of the user including digital profile biometric data of the user or digital profile images of the user, cause the at least one monitoring operation to be executed including (i) remove the digital profile biometric data or digital profile images of the user, or (ii) allow the digital profile biometric data or digital profile images to remain within the computer network environment.

In another aspect, a computer-implemented method for detecting and monitoring a digital profile of a user within a computer network environment is provided. The computer-implemented method is implemented by a computer system that includes at least one memory device and at least one processor in communication with the at least one memory device and in communication with one or more user computer devices. The computer-implemented method comprising: (i) receiving user data from a user device of the one or more user computer devices; (ii) executing a machine learning model to identify a digital profile of the user from the received user data including extracting digital profile data from the received user data; (iii) detecting, using the machine learning model and the identified digital profile of the user, an instance of the digital profile data stored within the computer network environment; (iv) causing an alert to be displayed on the user device advising the user of the detected instance of the digital profile data; (v) receiving user input from the user device in response to the alert; and (vi) determining at least one monitoring operation for monitoring the detected instance of the digital profile data based upon the received user input.

In another embodiment, the computer-implemented method described above with any combination of the features described herein may further include causing the alert to be displayed on the user device by transmitting, to the user device, executable instructions that cause a plurality of icons to be displayed on the user device, wherein each icon is associated with a monitoring operation for the detected instance of the digital profile data.

In another embodiment, the computer-implemented method described above with any combination of the features described herein may further include receiving user input from the user device including at least one icon selected by the user and associated with one of the monitoring operations.

In another embodiment, the computer-implemented method described above with any combination of the features described herein may further include implementing the monitoring operation associated with the at least one icon selected by the user.

In another embodiment, the computer-implemented method described above with any combination of the features described herein may further include generating a monitoring plan for monitoring the detected instance of the digital profile data for the user, the monitoring plan including the one or more monitoring operations executed by the machine learning model and in response to the at least one icon selected by the user.

In another embodiment, the computer-implemented method described above with any combination of the features described herein may further include executing the one or more monitoring operations associated with the monitoring plan.

In another embodiment, the computer-implemented method described above with any combination of the features described herein may further include causing a report representing one or more results of the one or more monitoring operations associated with the monitoring plan to be displayed on the user device.

In another embodiment, the computer-implemented method described above with any combination of the features described herein may further wherein each of the one or more monitoring operations comprises at least one of: removing the detected instance of the digital profile data; restricting access to the detected instance of the digital profile data; obfuscating or masking the digital profile data of the detected instance; or encrypting the digital profile data of the detected instance.

In another embodiment, the computer-implemented method described above with any combination of the features described herein may further include: analyzing the detected instance of the digital profile data using a natural language processing model to detect sensitive data; encrypting at least a portion of the instance of the digital profile data; and causing the encrypted digital profile data of the user to overwrite the detected instance of the digital profile data stored within the computer network environment.

In another embodiment, the computer-implemented method described above with any combination of the features described herein may further include: analyzing the detected instance of the digital profile data using a natural language processing model to detect sensitive data; updating the instance of the digital profile by removing the sensitive data from the instance of the digital profile; and causing the updated digital profile to replace the detected instance of the digital profile data stored within the computer network environment.

In another embodiment, the computer-implemented method described above with any combination of the features described herein may further include: causing a plurality of icons to be displayed on the user device, wherein each icon is associated with a monitoring operation for the detected instance of the digital profile data including a predefined privacy setting, each privacy setting corresponding to a level of data accessibility, wherein the user selection of an icon automatically adjusts the level of the data accessibility for the digital profile data.

In another embodiment, the computer-implemented method described above with any combination of the features described herein may further include: removing the detected digital profile data by transmitting a data removal command to at least one remote platform or repository included within the computer network environment, wherein the data removal command includes executable instructions for causing deletion, masking, or anonymization of the digital profile data.

In another embodiment, the computer-implemented method described above with any combination of the features described herein may further include wherein the data removal command further includes executable instructions for causing a message to be presented to an administrator of the remote platform or repository to ensure permanent removal of the detected digital profile data.

In another embodiment, the computer-implemented method described above with any combination of the features described herein may further include: analyzing an external data source for additional user data; updating the digital profile data of the digital profile of the user based upon the additional user data; identifying an additional instance of the digital profile data within the computer network environment based upon the updated digital profile data of the digital profile, and modifying the at least one monitoring operation to incorporate the additional instance of the digital profile data.

In another embodiment, the computer-implemented method described above with any combination of the features described herein may further include: generating a monitoring plan including one or more monitoring operations; generating one or more parameters associated with the execution of the one or more monitoring operations of the monitoring plan; and implementing the one or more monitoring operations based upon the one or more parameters, wherein the one or more parameters include at least one of: (i) a time interval for attempting to detect an additional instance of the digital profile data; (ii) a retention policy indicating how long the digital profile data or monitoring results are stored; and (iii) a trigger condition for additional monitoring operations or expanded data searches.

In another embodiment, the computer-implemented method described above with any combination of the features described herein may further include: generating a monitoring plan including one or more monitoring operations, the monitoring plan based upon user input received from the user device, wherein the user input includes selecting a desired privacy threshold for the user, specifying an instance of a digital profile data to monitor, or adjusting parameters of the monitoring operations.

In another embodiment, the computer-implemented method described above with any combination of the features described herein may further include: using the machine learning model to detect one or more instances of the digital profile data including one or more compromised passwords of the user; and causing any online accounts associated with the one or more compromised passwords to be closed.

In another embodiment, the computer-implemented method described above with any combination of the features described herein may further include: using the machine learning model to detect one or more instances of the digital profile data including an email address of the user subscribed to one or more websites; and causing the email address to be unsubscribed to the one or more websites.

In another embodiment, the computer-implemented method described above with any combination of the features described herein may further include: receiving the user data from the user device including biometric data of the user or facial recognition data of the user; and executing the machine learning model to identify a digital profile of the user including digital profile biometric data of the user or digital profile images of the user.

In another embodiment, the computer-implemented method described above with any combination of the features described herein may further include: in response to identifying the digital profile of the user including digital profile biometric data of the user or digital profile images of the user, executing the at least one monitoring operation including (i) removing the digital profile biometric data or digital profile images of the user, or (ii) allowing the digital profile biometric data or digital profile images to remain within the computer network environment.

In another aspect, at least one non-transitory computer-readable media having computer-executable instructions embodied thereon is provided. When executed by a computer system that includes at least one memory device and at least one processor in communication with the at least one memory device and one or more user computer devices, the computer-executable instructions cause the at least one processor to: (i) receive user data from a user device of the one or more user computer devices; (ii) execute a machine learning model to identify a digital profile of the user from the received user data including extracting digital profile data from the received user data; (iii) detect, using the machine learning model and the identified digital profile of the user, an instance of the digital profile data stored within the computer network environment; (iv) cause an alert to be displayed on the user device advising the user of the detected instance of the digital profile data; (v) receive user input from the user device in response to the alert; and (vi) determine at least one monitoring operation for monitoring the detected instance of the digital profile data based upon the received user input.

In another embodiment, the at least one non-transitory computer-readable media including computer-executable instructions as described above in any combination of the steps described herein may further cause the at least one processor to cause the alert to be displayed on the user device by transmitting, to the user device, executable instructions that cause a plurality of icons to be displayed on the user device, wherein each icon is associated with a monitoring operation for the detected instance of the digital profile data.

In another embodiment, the at least one non-transitory computer-readable media including computer-executable instructions as described above in any combination of the steps described herein may further cause the at least one processor to receive user input from the user device including at least one icon selected by the user and associated with one of the monitoring operations.

In another embodiment, the at least one non-transitory computer-readable media including computer-executable instructions as described above in any combination of the steps described herein may further cause the at least one processor to implement the monitoring operation associated with the at least one icon selected by the user.

In another embodiment, the at least one non-transitory computer-readable media including computer-executable instructions as described above in any combination of the steps described herein may further cause the at least one processor to generate a monitoring plan for monitoring the detected instance of the digital profile data for the user, the monitoring plan including the one or more monitoring operations executed by the machine learning model and in response to the at least one icon selected by the user.

In another embodiment, the at least one non-transitory computer-readable media including computer-executable instructions as described above in any combination of the steps described herein may further cause the at least one processor to execute the one or more monitoring operations associated with the monitoring plan.

In another embodiment, the at least one non-transitory computer-readable media including computer-executable instructions as described above in any combination of the steps described herein may further cause the at least one processor to cause a report representing one or more results of the one or more monitoring operations associated with the monitoring plan to be displayed on the user device.

In another embodiment, the at least one non-transitory computer-readable media including computer-executable instructions as described above in any combination of the steps described herein wherein each of the one or more monitoring operations comprises at least one of: remove the detected instance of the digital profile data; restrict access to the detected instance of the digital profile data; obfuscate or mask the digital profile data of the detected instance; or encrypt the digital profile data of the detected instance.

In another embodiment, the at least one non-transitory computer-readable media including computer-executable instructions as described above in any combination of the steps described herein may further cause the at least one processor to: analyze the detected instance of the digital profile data using a natural language processing model to detect sensitive data; encrypt at least a portion of the instance of the digital profile data; and cause the encrypted digital profile data of the user to overwrite the detected instance of the digital profile data stored within the computer network environment.

In another embodiment, the at least one non-transitory computer-readable media including computer-executable instructions as described above in any combination of the steps described herein may further cause the at least one processor to: analyze the detected instance of the digital profile data using a natural language processing model to detect sensitive data; update the instance of the digital profile by removing the sensitive data from the instance of the digital profile; and cause the updated digital profile to replace the detected instance of the digital profile data stored within the computer network environment.

In another embodiment, the at least one non-transitory computer-readable media including computer-executable instructions as described above in any combination of the steps described herein may further cause the at least one processor to: cause a plurality of icons to be displayed on the user device, wherein each icon is associated with a monitoring operation for the detected instance of the digital profile data including a predefined privacy setting, each privacy setting corresponding to a level of data accessibility, wherein the user selection of an icon automatically adjusts the level of the data accessibility for the digital profile data.

In another embodiment, the at least one non-transitory computer-readable media including computer-executable instructions as described above in any combination of the steps described herein may further cause the at least one processor to remove the detected digital profile data by transmitting a data removal command to at least one remote platform or repository included within the computer network environment, wherein the data removal command includes executable instructions for causing deletion, masking, or anonymization of the digital profile data.

In another embodiment, the at least one non-transitory computer-readable media including computer-executable instructions as described above in any combination of the steps described herein wherein the data removal command further includes executable instructions for causing a message to be presented to an administrator of the remote platform or repository to ensure permanent removal of the detected digital profile data.

In another embodiment, the at least one non-transitory computer-readable media including computer-executable instructions as described above in any combination of the steps described herein may further cause the at least one processor to: analyze an external data source for additional user data; update the digital profile data of the digital profile of the user based upon the additional user data; identify an additional instance of the digital profile data within the computer network environment based upon the updated digital profile data of the digital profile, and modify the at least one monitoring operation to incorporate the additional instance of the digital profile data.

In another embodiment, the at least one non-transitory computer-readable media including computer-executable instructions as described above in any combination of the steps described herein may further cause the at least one processor to: generate a monitoring plan including one or more monitoring operations; generate one or more parameters associated with the execution of the one or more monitoring operations of the monitoring plan; and implement the one or more monitoring operations based upon the one or more parameters, wherein the one or more parameters include at least one of: (i) a time interval for attempting to detect an additional instance of the digital profile data; (ii) a retention policy indicating how long the digital profile data or monitoring results are stored; and (iii) a trigger condition for additional monitoring operations or expanded data searches.

In another embodiment, the at least one non-transitory computer-readable media including computer-executable instructions as described above in any combination of the steps described herein may further cause the at least one processor to: generate a monitoring plan including one or more monitoring operations, the monitoring plan based upon user input received from the user device, wherein the user input includes selecting a desired privacy threshold for the user, specifying an instance of a digital profile data to monitor, or adjusting parameters of the monitoring operations.

In another embodiment, the at least one non-transitory computer-readable media including computer-executable instructions as described above in any combination of the steps described herein may further cause the at least one processor to: use the machine learning model to detect one or more instances of the digital profile data including one or more compromised passwords of the user; and cause any online accounts associated with the one or more compromised passwords to be closed.

In another embodiment, the at least one non-transitory computer-readable media including computer-executable instructions as described above in any combination of the steps described herein may further cause the at least one processor to: use the machine learning model to detect one or more instances of the digital profile data including an email address of the user subscribed to one or more websites; and cause the email address to be unsubscribed to the one or more websites.

In another embodiment, the at least one non-transitory computer-readable media including computer-executable instructions as described above in any combination of the steps described herein may further cause the at least one processor to: receive the user data from the user device including biometric data of the user or facial recognition data of the user; and execute the machine learning model to identify a digital profile of the user including digital profile biometric data of the user or digital profile images of the user.

In another embodiment, the at least one non-transitory computer-readable media including computer-executable instructions as described above in any combination of the steps described herein may further cause the at least one processor to: in response to identifying the digital profile of the user including digital profile biometric data of the user or digital profile images of the user, cause the at least one monitoring operation to be executed including (i) remove the digital profile biometric data or digital profile images of the user, or (ii) allow the digital profile biometric data or digital profile images to remain within the computer network environment.

### MACHINE LEARNING & OTHER MATTERS

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

In some embodiments, digital profile monitoring server 202 is configured to implement machine learning, such that server 202 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text, and/or numbers. ML outputs may include, but are not limited to identified objects, items classifications, data patterns and/or other data extracted from the inputs. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of user date with known digital profiles. Such information may include, for example, information associated with a plurality of users each associated with user data that is further associated with a digital profile. This training data may enable training the ML module to analyze historical user data and determine a digital profile for each user included within the historical user data. The ML module may also be trained to detect instances of digital profile data from the determined digital profiles, and implement a monitoring plan for those detected instances.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments described herein. Voice bots or chat bots may also be configured to utilize artificial intelligence and/or machine learning techniques as described herein. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as image, mobile device, vehicle telematics, and/or intelligent home telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing – either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs may be provided the processing element may, based upon the discovered rule, accurately predict the correct output. In unsupervised machine learning, the processing element may be required to find its own structure in unlabeled example inputs. In one embodiment, machine learning techniques may be used to extract the relevant user data from user computer devices or external data sources to determine the digital profile data for a user, and then detected instances of the digital profile data within external platforms.

In one embodiment, a processing element may be trained by providing it with a large sample of conventional analog and/or digital, still and/or moving (i.e., video) image data, telematics data, and/or other data relating to digital profiles.

Based upon these analyses, the processing element may learn how to identify characteristics and patterns that may then be applied to analyzing user data, image data, mobile device data, and/or other data to then identify digital profile data. For example, the processing element may learn, with the customer’s permission or affirmative consent, to identify the profile data of the user. As a result, at the time of an instance that relating to the digital profile data, providing prompt and accurate service to the user may be provided such as accurate insurance claim handling, and prompt outputting of profile monitoring plans.

In some embodiments, voice bots or chatbots, such as those discussed herein, may be configured to utilize AI (artificial intelligence) and/or ML (machine learning) techniques. For instance, the chatbot may be a large language model such as OpenAI GPT-4, Meta LLaMa, or Google PaML 2. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples may be example only and may be thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples may be not intended to limit in any way the definition and/or meaning of the term database. Examples of RDBMS’s include, but may be not limited to, Oracle® Database, MySQL, IBM® DB2, Microsoft® SQL Server, Sybase®, and PostgreSQL. However, any database may be used that may enable the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.).

As used herein, the terms “software” and “firmware” may be interchangeable and include any computer program stored in memory for execution by a processor, including RAM memory, ROM memory, EPROM memory, EEPROM memory, and non-volatile RAM (NVRAM) memory. The above memory types may be example only and may be thus not limiting as to the types of memory usable for storage of a computer program.

In another embodiment, a computer program is provided, and the program is embodied on a computer-readable medium. In one exemplary embodiment, the system is executed on a single computer system, without requiring a connection to a server computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes may be not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or action or operation recited in the singular and preceded by the word “a” or “an” should be understood as not excluding plural elements or action or operations, unless such exclusion is explicitly recited. Furthermore, references to “exemplary embodiment” or “one embodiment” of the present disclosure may be not intended to be interpreted as excluding the existence of additional embodiments that also incorporate the recited features.

The patent claims at the end of this document may be not intended to be construed under 35 U.S.C. § 112(f) unless traditional means-plus-function language is expressly recited, such as “means for” or “action or operation for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples may be intended to be within the scope of the claims if they have structural elements that do not differ from the literal language of the claims, or if they include equivalent structural elements with insubstantial differences from the literal language of the claims.

We claim:

1. A computer system for detecting and monitoring a digital profile of a user within a computer network environment, the computer system comprising at least one memory device, and at least one processor in communication with the at least one memory device, the computer system in communication with one or more user computer devices, the at least one processor programmed to:
receive user data from a user device of the one or more user computer devices;
execute a machine learning model to identify a digital profile of the user from the received user data including extracting digital profile data from the received user data;
detect, using the machine learning model and the identified digital profile of the user, an instance of the digital profile data stored within the computer network environment;
cause an alert to be displayed on the user device advising the user of the detected instance of the digital profile data;
receive user input from the user device in response to the alert; and
determine at least one monitoring operation for monitoring the detected instance of the digital profile data based upon the received user input.

2. The computer system of claim 1, wherein the at least one processor is further programmed to cause the alert to be displayed on the user device by transmitting, to the user device, executable instructions that cause a plurality of icons to be displayed on the user device, wherein each icon is associated with a monitoring operation for the detected instance of the digital profile data.

3. The computer system of claim 2, wherein the at least one processor is further programmed to receive user input from the user device including at least one icon selected by the user and associated with one of the monitoring operations.

4. The computer system of claim 3, wherein the at least one processor is further programmed to implement the monitoring operation associated with the at least one icon selected by the user.

5. The computer system of claim 4, wherein the at least one processor is further programmed to generate a monitoring plan for monitoring the detected instance of the digital profile data for the user, the monitoring plan including the one or more monitoring operations executed by the machine learning model and in response to the at least one icon selected by the user.

6. The computer system of claim 5, wherein the at least one processor is further programmed to execute the one or more monitoring operations associated with the monitoring plan.

7. The computer system of claim 6, wherein the at least one processor is further programmed to cause a report representing one or more results of the one or more monitoring operations associated with the monitoring plan to be displayed on the user device.

8. The computer system of claim 1, wherein each of the one or more monitoring operations comprises at least one of: remove the detected instance of the digital profile data; restrict access to the detected instance of the digital profile data; obfuscate or mask the digital profile data of the detected instance; or encrypt the digital profile data of the detected instance.

9. The computer system of claim 1, wherein the at least one processor is further programmed to:
analyze the detected instance of the digital profile data using a natural language processing model to detect sensitive data;
encrypt at least a portion of the instance of the digital profile data; and
cause the encrypted digital profile data of the user to overwrite the detected instance of the digital profile data stored within the computer network environment.

10. The computer system of claim 1, wherein the at least one processor is further programmed to:
analyze the detected instance of the digital profile data using a natural language processing model to detect sensitive data;
update the instance of the digital profile by removing the sensitive data from the instance of the digital profile; and
cause the updated digital profile to replace the detected instance of the digital profile data stored within the computer network environment.

11. The computer system of claim 1, wherein the at least one processor is further programmed to:
cause a plurality of icons to be displayed on the user device, wherein each icon is associated with a monitoring operation for the detected instance of the digital profile data including a predefined privacy setting, each privacy setting corresponding to a level of data accessibility, wherein the user selection of an icon automatically adjusts the level of the data accessibility for the digital profile data.

12. The computer system of claim 1, wherein the at least one processor is further programmed to: remove the detected digital profile data by transmitting a data removal command to at least one remote platform or repository included within the computer network environment, wherein the data removal command includes executable instructions for causing deletion, masking, or anonymization of the digital profile data.

13. The computer system of claim 12, wherein the data removal command further includes executable instructions for causing a message to be presented to an administrator of the remote platform or repository to ensure permanent removal of the detected digital profile data.

14. The computer system of claim 1, wherein the at least one processor is further programmed to:
analyze an external data source for additional user data,
update the digital profile data of the digital profile of the user based upon the additional user data;
identify an additional instance of the digital profile data within the computer network environment based upon the updated digital profile data of the digital profile, and
modify the at least one monitoring operation to incorporate the additional instance of the digital profile data.

15. The computer system of claim 1, wherein the at least one processor is further programmed to:
generate a monitoring plan including one or more monitoring operations;
generate one or more parameters associated with the execution of the one or more monitoring operations of the monitoring plan; and
implement the one or more monitoring operations based upon the one or more parameters, wherein the one or more parameters include at least one of: (i) a time interval for attempting to detect an additional instance of the digital profile data; (ii) a retention policy indicating how long the digital profile data or monitoring results are stored; and (iii) a trigger condition for additional monitoring operations or expanded data searches.

16. The computer system of claim 1, wherein the at least one processor is further programmed to generate a monitoring plan including one or more monitoring operations, the monitoring plan based upon user input received from the user device, wherein the user input includes selecting a desired privacy threshold for the user, specifying an instance of a digital profile data to monitor, or adjusting parameters of the monitoring operations.

17. The computer system of claim 1, wherein the at least one processor is further programmed to:
use the machine learning model to detect one or more instances of the digital profile data including one or more compromised passwords of the user; and
cause any online accounts associated with the one or more compromised passwords to be closed.

18. The computer system of claim 1, wherein the at least one processor is further programmed to:
use the machine learning model to detect one or more instances of the digital profile data including an email address of the user subscribed to one or more websites; and
cause the email address to be unsubscribed to the one or more websites.

19. The computer system of claim 1, wherein the at least one processor is further programmed to:
receive the user data from the user device including biometric data of the user or facial recognition data of the user; and
execute the machine learning model to identify a digital profile of the user including digital profile biometric data of the user or digital profile images of the user.

20. The computer system of claim 19, wherein the at least one processor is further programmed to:
in response to identifying the digital profile of the user including digital profile biometric data of the user or digital profile images of the user, cause the at least one monitoring operation to be executed including (i) remove the digital profile biometric data or digital profile images of the user, or (ii) allow the digital profile biometric data or digital profile images to remain within the computer network environment.

21. A computer-implemented method for detecting and monitoring a digital profile of a user within a computer network environment, the computer-implemented method implemented by a computer system including at least one memory device and at least one processor in communication with the at least one memory device and in communication with one or more user computer devices, the computer-implemented method comprising:
receiving user data from a user device of the one or more user computer devices;
executing a machine learning model to identify a digital profile of the user from the received user data including extracting digital profile data from the received user data;
detecting, using the machine learning model and the identified digital profile of the user, an instance of the digital profile data stored within the computer network environment;
causing an alert to be displayed on the user device advising the user of the detected instance of the digital profile data;
receiving user input from the user device in response to the alert; and
determining at least one monitoring operation for monitoring the detected instance of the digital profile data based upon the received user input.

22. At least one non-transitory computer-readable media having computer-executable instructions embodied thereon, wherein when executed by a computer system including at least one memory device and at least one processor in communication with the at least one memory device and one or more user computer devices, the computer-executable instructions cause the at least one processor to:
receive user data from a user device of the one or more user computer devices;
execute a machine learning model to identify a digital profile of the user from the received user data including extracting digital profile data from the received user data;
detect, using the machine learning model and the identified digital profile of the user, an instance of the digital profile data stored within the computer network environment;
cause an alert to be displayed on the user device advising the user of the detected instance of the digital profile data;
receive user input from the user device in response to the alert; and
determine at least one monitoring operation for monitoring the detected instance of the digital profile data based upon the received user input.
